(19) United States
(12) Patent Application Publication
(10) Pub. No.: US 2024/0014955 A1
(43) Pub. Date: Jan. 11, 2024

(54) PERFORMING A CHANNEL ACCESS PROCEDURE ON MULTIPLE COMPONENT CARRIERS IN A SHARED RADIO FREQUENCY SPECTRUM BAND

(71) Applicant: QUALCOMM Incorporated, San Diego, CA (US)

(72) Inventors: Stelios STEFANATOS, San Diego, CA (US); Arthur GUBESKYS, San Diego, CA (US); Shuanshuan WU, San Diego, CA (US); Parisa CHERAGHI, Cambridge (GB)

(21) Appl. No.: 18/253,907

(22) PCT Filed: Jan. 24, 2022
(86) PCT No.: PCT/US2022/013546

§ 371 Date: May 22, 2023

(30) Foreign Application Priority Data
Jan. 25, 2021 (GR) 20210100044

(51) Int. Cl. H04L 5/00; H04W 74/08

(52) U.S. Cl. CPC H04L 5/001; H04W 74/08

(57) ABSTRACT

Methods, systems, and devices for wireless communication are described. A communication device, such as a user equipment (UE) may determine a transmit diversity configuration indicating a transmit diversity criterion for declaring a result of a channel access procedure for a plurality of component carriers in a shared radio frequency spectrum band. The UE may perform the channel access procedure for the plurality of component carriers in the shared radio frequency spectrum band to determine the result of the channel access procedure based at least in part on the transmit diversity criterion. As a result, the UE may transmit or refrain from transmitting a message over at least one component carrier of the plurality of component carriers based at least in part on the result of the channel access procedure.

### CROSS REFERENCE

The present application is a 371 national stage filing of International PCT Application No. PCT/US2022/013546 by STEFANATOS et al. entitled “PERFORMING A CHANNEL ACCESS PROCEDURE ON MULTIPLE COMPONENT CARRIERS IN A SHARED RADIO FREQUENCY SPECTRUM BAND,” filed Jan. 24, 2022; and claims priority to Greece Patent Application No. 20210100044 by STEFANATOS et al., entitled “PERFORMING A CHANNEL ACCESS PROCEDURE ON MULTIPLE COMPONENT CARRIERS IN A SHARED RADIO FREQUENCY SPECTRUM BAND,” filed Jan. 25, 2021, each of which is assigned to the assignee hereof, and each of which is expressly incorporated by reference in its entirety herein.

### INTRODUCTION

The following relates to wireless communications, and more specifically to managing a channel access procedure for the wireless communications.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

A method for multicarrier wireless communication at a UE in a wireless communications system is described. The method may include determining a transmit diversity configuration indicating a transmit diversity criterion for declaring a result of a channel access procedure for a set of multiple CCs in a shared radio frequency spectrum band. The method may include performing the channel access procedure for the set of multiple CCs in the shared radio frequency spectrum band to determine the result of the channel access procedure based on the transmit diversity criterion. The method may include transmitting or refraining from transmitting a message over at least one CC of the set of multiple CCs based on the result of the channel access procedure.

An apparatus for multicarrier wireless communication at a UE in a wireless communications system is described. The apparatus may include a processor, and memory coupled to the processor, the processor configured to determine a transmit diversity configuration indicating a transmit diversity criterion for declaring a result of a channel access procedure for a set of multiple CCs in a shared radio frequency spectrum band. The processor is configured to perform the channel access procedure for the set of multiple CCs in the shared radio frequency spectrum band to determine the result of the channel access procedure based on the transmit diversity criterion. The processor is configured to transmit or refrain from transmitting a message over at least one CC of the set of multiple CCs based on the result of the channel access procedure.

Another apparatus for multicarrier wireless communication at a UE in a wireless communications system is described. The apparatus may include means for determining a transmit diversity configuration indicating a transmit diversity criterion for declaring a result of a channel access procedure for a set of multiple CCs in a shared radio frequency spectrum band. The apparatus may include means for performing the channel access procedure for the set of multiple CCs in the shared radio frequency spectrum band to determine the result of the channel access procedure based on the transmit diversity criterion. The apparatus may include means for transmitting or refraining from transmitting a message over at least one CC of the set of multiple CCs based on the result of the channel access procedure.

A non-transitory computer-readable medium storing code for multicarrier wireless communication at a first UE in a wireless communications system is described. The code may include instructions executable by a processor to determine a transmit diversity configuration indicating a transmit diversity criterion for declaring a result of a channel access procedure for a set of multiple CCs in a shared radio frequency spectrum band. The code may include instructions executable by a processor to perform the channel access procedure for the set of multiple CCs in the shared radio frequency spectrum band to determine the result of the channel access procedure based on the transmit diversity criterion. The code may include instructions executable by a processor to transmit or refrain from transmitting a message over at least one CC of the set of multiple CCs based on the result of the channel access procedure.

Some examples of the method, apparatuses, and non-transitory computer-readable medium described herein may further include operations, features, means, or instructions for receiving a control message indicating the transmit diversity configuration and where the control message includes a radio resource control (RRC) message, a medium access control control element (MAC-CE) message, or a downlink control information (DCI) message, or a combination thereof.

Some examples of the method, apparatuses, and non-transitory computer-readable medium described herein may further include operations, features, means, or instructions for receiving, from a second UE or a node, an indication of the transmit diversity criterion for declaring the result of the channel access procedure for the set of multiple CCs in the shared radio frequency spectrum band based on an observed interference level satisfying a threshold.

Some examples of the method, apparatuses, and non-transitory computer-readable medium described herein may further include operations, features, means, or instructions for receiving the transmit diversity configuration indicating a redundancy number and transmitting or refraining from transmitting the message over the at least one CC of the set of multiple CCs based on the redundancy number.

Some examples of the method, apparatuses, and non-transitory computer-readable medium described herein may further include operations, features, means, or instructions for transmitting or refraining from transmitting the message over the at least one CC of the set of multiple CCs based on a transmit diversity threshold number. The transmit diversity threshold number may be a product of a redundancy number and a target transmit diversity number of CCs specified for transmission of the message.

In some examples of the method, apparatuses, and non-transitory computer-readable medium described herein, the redundancy number may be greater than or equal to one.

In some examples of the method, apparatuses, and non-transitory computer-readable medium described herein, the product of the redundancy number and the target transmit diversity number may be less than or equal to a total number of the set of multiple CCs.

In some examples of the method, apparatuses, and non-transitory computer-readable medium described herein, the transmit diversity threshold number may be a multiple of the target transmit diversity number.

In some examples of the method, apparatuses, and non-transitory computer-readable medium described herein, the redundancy number may be preconfigured.

In some examples of the method, apparatuses, and non-transitory computer-readable medium described herein, the redundancy number may be based on a type of application of the message.

In some examples of the method, apparatuses, and non-transitory computer-readable medium described herein, the redundancy number may be based on the total number of CCs in the wireless communications system.

In some examples of the method, apparatuses, and non-transitory computer-readable medium described herein, the redundancy number may be based on a packet delay budget (PDB) associated with the channel access procedure.

In some examples of the method, apparatuses, and non-transitory computer-readable medium described herein, the redundancy number may be based on a period when the channel access procedure may be performed and a PDB associated with the channel access procedure.

In some examples of the method, apparatuses, and non-transitory computer-readable medium described herein, the redundancy number may be based on a defined number of CCs specified for the message.

In some examples of the method, apparatuses, and non-transitory computer-readable medium described herein, the redundancy number may be determined based on interference information for one or more CCs of the set of multiple CCs.

Some examples of the method, apparatuses, and non-transitory computer-readable medium described herein may further include operations, features, means, or instructions for receiving the interference information from a node in wireless communication with the first UE, or a second UE in sidelink communication with the first UE, or both. Some examples of the method, apparatuses, and non-transitory computer-readable medium described herein may further include operations, features, means, or instructions for transmitting or refraining from transmitting the message over the at least one CC of the set of multiple CCs based on the interference information.

Some examples of the method, apparatuses, and non-transitory computer-readable medium described herein may further include operations, features, means, or instructions for determining a CBR based on measuring one or more reference signals communicated via the one or more CCs of the set of multiple CCs. The interference information including the CBR.

Some examples of the method, apparatuses, and non-transitory computer-readable medium described herein may further include operations, features, means, or instructions for determining a set of multiple previous results of a set of multiple previous channel access procedures performed by the first UE, estimating that the one or more CCs of the set of multiple CCs may be available for transmission of the message based on the set of multiple previous results of the set of multiple previous channel access procedures performed by the first UE. The redundancy number may be determined based on the estimated one or more CCs of the set of multiple CCs that may be available for transmission of the message.

Some examples of the method, apparatuses, and non-transitory computer-readable medium described herein may further include operations, features, means, or instructions for determining one or more CCs of the set of multiple CCs may be available for transmission of the message based on the channel access procedure. Some examples of the method, apparatuses, and non-transitory computer-readable medium described herein may further include operations, features, means, or instructions for declaring the result as a channel access failure based on a number of the one or more CCs satisfying a transmit diversity threshold number specified in the transmit diversity criterion. The number of one or more CCs may be available for transmission of the message. Some examples of the method, apparatuses, and non-transitory computer-readable medium described herein may further include operations, features, means, or instructions for refraining from transmitting the message based on the channel access failure.

Some examples of the method, apparatuses, and non-transitory computer-readable medium described herein may further include operations, features, means, or instructions for determining one or more CCs of the set of multiple CCs may be available for transmission of the message based on the channel access procedure and declaring the result as a channel access success based on a number of the one or more CCs satisfying a transmit diversity threshold number specified in the transmit diversity criterion, where the number of one or more CCs may be available for transmission of the message.

Some examples of the method, apparatuses, and non-transitory computer-readable medium described herein may further include operations, features, means, or instructions for transmitting the message on the one or more CCs based on declaring the result the channel access success.

Some examples of the method, apparatuses, and non-transitory computer-readable medium described herein may further include operations, features, means, or instructions for determining a probability of the result of the channel access procedure using a probability model and declaring the result of the channel access procedure for based on the probability.

A method for wireless communication at a first UE is described. The method may include measuring one or more sidelink reference signals to determine an observed interference level at the first UE. The method may include communicating, to a second UE, a message including an indication of a transmit diversity criterion for declaring a result of a channel access procedure for a set of multiple CCs in a shared radio frequency spectrum band based on the observed interference level satisfying a threshold.

An apparatus for wireless communication at a first UE is described. The apparatus may include a processor, and memory coupled to the processor, the processor configured to measure one or more sidelink reference signals to determine an observed interference level at the first UE. The processor is configured to communicate, to a second UE, a message including an indication of a transmit diversity criterion for declaring a result of a channel access procedure for a set of multiple CCs in a shared radio frequency spectrum band based on the observed interference level satisfying a threshold.

Another apparatus for wireless communication at a first UE is described. The apparatus may include means for measuring one or more sidelink reference signals to determine an observed interference level at the first UE. The apparatus may include means for communicating, to a second UE, a message including an indication of a transmit diversity criterion for declaring a result of a channel access procedure for a set of multiple CCs in a shared radio frequency spectrum band based on the observed interference level satisfying a threshold.

A non-transitory computer-readable medium storing code for wireless communication at a first UE is described. The code may include instructions executable by a processor to measure one or more sidelink reference signals to determine an observed interference level at the first UE. The code may include instructions executable by a processor to communicate, to a second UE, a message including an indication of a transmit diversity criterion for declaring a result of a channel access procedure for a set of multiple CCs in a shared radio frequency spectrum band based on the observed interference level satisfying a threshold.

In some examples of the method, apparatuses, and non-transitory computer-readable medium described herein, communicating the message may include operations, features, means, or instructions for communicating the message including the indication of the transmit diversity criterion that specifies a transmit diversity threshold number for declaring the result as a channel access failure based on a number of one or more CCs satisfying the transmit diversity threshold number specified in the transmit diversity criterion, where the number of one or more CCs may be available for transmission.

In some examples of the method, apparatuses, and non-transitory computer-readable medium described herein, communicating the message may include operations, features, means, or instructions for communicating the message including the indication of the transmit diversity criterion that specifies a transmit diversity threshold number for declaring the result as a channel access success based on a number of one or more CCs satisfying the transmit diversity threshold number specified in the transmit diversity criterion, where the number of one or more CCs may be available for transmission.

In some examples of the method, apparatuses, and non-transitory computer-readable medium described herein, communicating the message may include operations, features, means, or instructions for communicating the message including the indication of the transmit diversity criterion that specifies a transmit diversity threshold number that may be a product of a redundancy number and a target transmit diversity number of CCs.

In some examples of the method, apparatuses, and non-transitory computer-readable medium described herein, the redundancy number may be greater than one.

In some examples of the method, apparatuses, and non-transitory computer-readable medium described herein, the transmit diversity threshold number may be a multiple of the target transmit diversity number.

A method for wireless communication at a node is described. The method may include transmitting a transmit diversity configuration indicating a transmit diversity criterion for declaring a result of a channel access procedure for a set of multiple CCs in a shared radio frequency spectrum band. The method may include measuring one or more reference signals to determine an observed interference level at the node. The method may include communicating, to a UE, a message including an indication of an updated transmit diversity criterion for declaring the result of the channel access procedure for the set of multiple CCs in the shared radio frequency spectrum band based on the observed interference level satisfying a threshold.

An apparatus for wireless communication at a node is described. The apparatus may include a processor, and memory coupled to the processor, the processor configured to transmit a transmit diversity configuration indicating a transmit diversity criterion for declaring a result of a channel access procedure for a set of multiple CCs in a shared radio frequency spectrum band. The processor is configured to measure one or more reference signals to determine an observed interference level at the node. The processor is configured to communicate, to a UE, a message including an indication of an updated transmit diversity criterion for declaring the result of the channel access procedure for the set of multiple CCs in the shared radio frequency spectrum band based on the observed interference level satisfying a threshold.

Another apparatus for wireless communication at a node is described. The apparatus may include means for transmitting a transmit diversity configuration indicating a transmit diversity criterion for declaring a result of a channel access procedure for a set of multiple CCs in a shared radio frequency spectrum band. The apparatus may include means for measuring one or more reference signals to determine an observed interference level at the node. The apparatus may include means for communicating, to a UE, a message including an indication of an updated transmit diversity criterion for declaring the result of the channel access procedure for the set of multiple CCs in the shared radio frequency spectrum band based on the observed interference level satisfying a threshold.

A non-transitory computer-readable medium storing code for wireless communication at a node is described. The code may include instructions executable by a processor to transmit a transmit diversity configuration indicating a transmit diversity criterion for declaring a result of a channel access procedure for a set of multiple CCs in a shared radio frequency spectrum band. The code may include instructions executable by a processor to measure one or more reference signals to determine an observed interference level at the node. The code may include instructions executable by a processor to communicate, to a UE, a message including an indication of an updated transmit diversity criterion for declaring the result of the channel access procedure for the set of multiple CCs in the shared radio frequency spectrum band based on the observed interference level satisfying a threshold.

### BRIEF DESCRIPTION OF THE DRAWINGS

FIGS. 1 and 2 illustrate examples of wireless communications systems that support performing a channel access procedure on multiple component carriers in a shared radio frequency spectrum band in accordance with one or more aspects of the present disclosure.

FIG. 3 illustrates an example of transmission scheme that supports performing a channel access procedure on multiple component carriers in a shared radio frequency spectrum band in accordance with one or more aspects of the present disclosure.

FIG. 4 illustrates an example of a process flow that supports performing a channel access procedure on multiple component carriers in a shared radio frequency spectrum band in accordance with one or more aspects of the present disclosure.

FIGS. 5 and 6 show block diagrams of devices that support performing a channel access procedure on multiple component carriers in a shared radio frequency spectrum band in accordance with one or more aspects of the present disclosure.

FIG. 7 shows a block diagram of a communications manager that supports performing a channel access procedure on multiple component carriers in a shared radio frequency spectrum band in accordance with one or more aspects of the present disclosure.

FIG. 8 shows a diagram of a system including a device that supports performing a channel access procedure on multiple component carriers in a shared radio frequency spectrum band in accordance with one or more aspects of the present disclosure.

FIGS. 9 and 10 show block diagrams of devices that support performing a channel access procedure on multiple component carriers in a shared radio frequency spectrum band in accordance with one or more aspects of the present disclosure.

FIG. 11 shows a block diagram of a communications manager that supports performing a channel access procedure on multiple component carriers in a shared radio frequency spectrum band in accordance with one or more aspects of the present disclosure.

FIG. 12 shows a diagram of a system including a device that supports performing a channel access procedure on multiple component carriers in a shared radio frequency spectrum band in accordance with one or more aspects of the present disclosure.

FIGS. 13 through 17 show flowcharts illustrating methods that support performing a channel access procedure on multiple component carriers in a shared radio frequency spectrum band in accordance with one or more aspects of the present disclosure.

### DETAILED DESCRIPTION

A wireless communications system may include various communication devices such as a UE and a base station (e.g., a node), which may provide wireless communication services to the UE. For example, such a base station may be a next-generation NodeB (referred to as a gNB) that may support multiple radio access technologies including 4G systems, such as 4G LTE, as well as 5G systems, which may be referred to as 5G NR, among other wireless communications systems (e.g., subsequent generations of wireless communications systems). In the wireless communications system, a communication device, such as a UE may transmit information to other communication devices (e.g., other UE, base stations) over one or multiple component carriers. As described herein, a component carrier may refer to a portion (e.g., block) of frequencies and wireless communications over multiple component carriers may be referred to as a multicarrier wireless communications. In some cases, the component carriers may be part of an unlicensed radio frequency spectrum band, and thereby shared with other communication devices (e.g., other UE) in the wireless communications system or other wireless communications systems. That is, the unlicensed radio frequency spectrum band is shared among communication devices (e.g., UEs) belonging to one or multiple communications systems. Thus, as described herein, a shared radio frequency spectrum band may refer to an unlicensed radio frequency spectrum band shared among communication devices. For example, an unlicensed channel may be shared between 4G systems, 5G systems, Wi-Fi communication devices, among other examples. As such, the unlicensed channel may be shared between various wireless communication systems. Due to the sharing of the component carriers, the UE may perform a channel access procedure (e.g., a listen-before-talk (LBT) procedure) to determine the availability of these component carriers. As described herein, a channel access procedure may refer to a procedure performed by a communication device to gain access to one or more channel over which transmissions are performed.

For example, the UE may determine whether the component carriers are available (i.e., not used by other communication devices) or unavailable (i.e., used by other communication devices) based on channel sensing operations as described herein. If the UE determines that the component carriers are available, the channel access procedure may be successful, and the UE may begin transmitting information (e.g., a message) on these component carriers. Otherwise, the UE may repeat the channel access procedure. In some cases, the UE may determine that some (e.g., not all) of the component carriers are available. For high reliability and low latency applications in the wireless communications system, techniques for performing channel access procedures on multiple different component carriers may be improved. Examples of high reliability and low latency applications include vehicle-to-everything (V2X), vehicle-to-vehicle (V2V), or a cellular V2X (CV2X), among other examples.

Various aspects of the present disclosure relate to configuring a UE with a transmit diversity configuration indicating a transmit diversity criterion or a transmit diversity criteria for declaring a result of a channel access procedure either a channel access success or a channel access failure for multiple component carriers in an unlicensed radio frequency spectrum band (also referred to as a shared radio frequency spectrum band). That is, as described herein, a transmit diversity configuration may refer to a configuration that indicates a transmit diversity criterion or a transmit diversity criteria for declaring a result of a channel access procedure. The UE may be configured with the above transmit diversity configuration via semi-static signaling, such as RRC signaling. Alternatively, the UE may be configured with the above transmit diversity configuration via dynamic signaling, such as MAC-CE signaling or DCI signaling. The UE may also be preconfigured with the above transmit diversity configuration as described herein.

Examples of a transmit diversity criterion or a transmit diversity criteria for declaring a result of a channel access procedure either a channel access success or a channel access failure for multiple component carriers in an unlicensed radio frequency spectrum band are provided below. As described herein, a result may refer to whether the channel access procedure was a success or a failure. The UE may perform a channel access procedure for multiple component carriers, and declare a result of the channel access procedure as a success when the UE determines that a number of available component carriers is equal to or greater than a target number of component carriers required to support a transmission. That is, the target number of component carriers required to support the transmission may be a minimum number of component carriers required to support the transmission.

The transmit diversity criterion may be that the UE declares the result of the channel access procedure as a success when the number of available component carriers is equal to or greater than the target number of component carriers required to support the transmission. Alternatively, the UE may perform the channel access procedure for the multiple component carriers, and declare the result of the channel access procedure as a failure when the UE determines that a number of available component carriers is less than the target (e.g., a minimum) number of component carriers to support the transmission. The transmit diversity criterion may be that the UE declares the result of the channel access procedure as a failure when the number of available component carriers is less than the target (e.g., a minimum) number of component carriers to support the transmission. Alternatively, the UE may declare the result of the channel access procedure as a failure, even when the UE determines that the number of available component carriers is greater than or equal to the target number of component carriers required to support the transmission. The transmit diversity criterion may be that the UE declares the result of the channel access procedure as a failure, even when the UE determines that the number of available component carriers is greater than or equal to the target number of component carriers required to support the transmission. Thus, a channel access procedure result declared by the UE given a determination regarding available component carriers may be referred to as a transmit diversity criterion.

For example, a UE may declare a result of a channel access procedure as a failure unless there is at least a multiple of the target number of component carriers available for the transmission. In other words, a UE may declare a result of a channel access procedure as a failure unless there are at least x times more available component carriers than required to support the transmission, where x is referred to as a redundancy number. The redundancy number may be an integer value (e.g., 1, 2, 3, etc.) or a real number (e.g., 1.2, 2.5, etc.). The redundancy number may be preconfigured for the UE. Alternatively, the redundancy number may be signaled by other communication devices (e.g., other UE, base stations) in the wireless communications system. In some examples, the redundancy number may be dependent on a type of application (e.g., a reliability-sensitive application), a PDB, or the target number of component carriers to support the transmission. In some other examples, the redundancy number may be dependent on an interference level experienced by the UE or by other communication devices in the wireless communications system. Thereby, other communication devices may signal the redundancy number to the UE based on the interference level experienced by the other communication devices.

Operations performed by the UE may provide one or more efficiencies for wireless communications in a wireless communications system. For example, by declaring a result of a channel access procedure either a channel access success or a channel access failure for multiple component carriers in an unlicensed radio frequency spectrum band, the UE may increase the reliability and reduce the latency of wireless communications over an unlicensed radio frequency spectrum band. Additionally, the UE may experience power saving, for example, by providing efficient channel access procedures in the wireless communications system.

Aspects of the disclosure are initially described in the context of wireless communications systems. Aspects of the disclosure are further illustrated by and described with reference to apparatus diagrams, system diagrams, and flowcharts that relate to performing a channel access procedure on multiple component carriers in a shared radio frequency spectrum band.

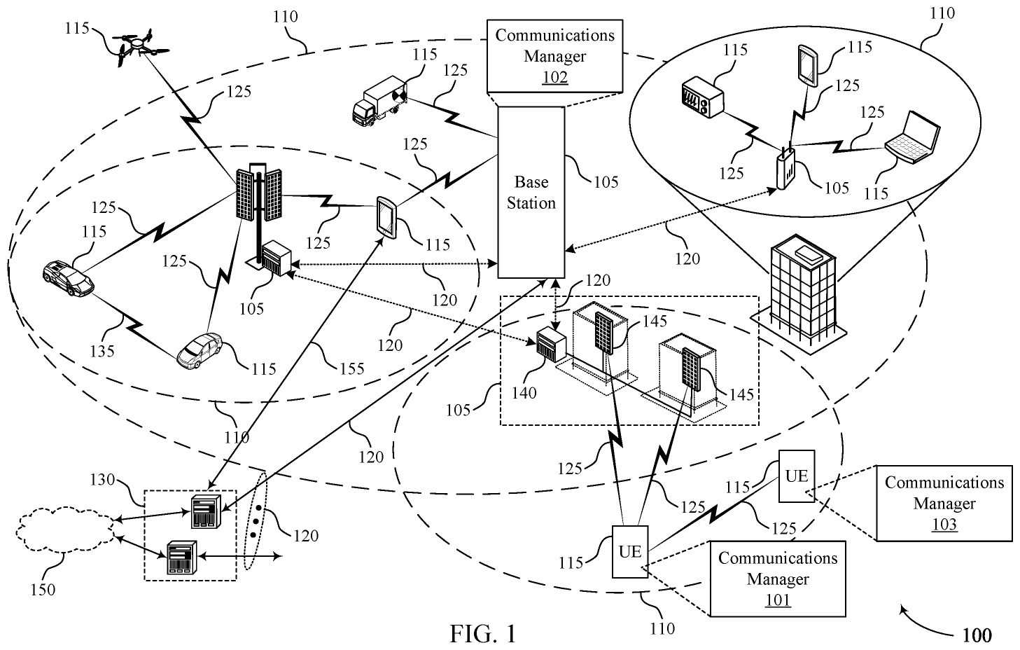

FIG. 1 illustrates an example of a wireless communications system 100 that supports performing a channel access procedure on multiple component carriers in a shared radio frequency spectrum band in accordance with one or more aspects of the present disclosure. The wireless communications system 100 may include one or more base stations 105, one or more UEs 115, and a core network 130. In some examples, the wireless communications system 100 may be an LTE network, an LTE-A network, an LTE-A Pro network, or an NR network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links. One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology. A UE 115 may communicate with the core network 130 through a communication link 155.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples. The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology). The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as OFDM or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs. The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation. A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers. A carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105.

Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The D2D communication link 135 may be an example of a communication channel, such as a sidelink communication channel, between vehicles (e.g., UEs 115). In some examples, vehicles may communicate using V2X communications, V2V communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, in the range of 300 MHz to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the EHF band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARM) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Techniques described herein, in addition to or as an alternative to be carried out between UEs 115 and base stations 105, may be implemented via additional or alternative wireless devices, including IAB nodes 104, distributed units (DUs) 165, centralized units (CUs) 160, radio units (RUs) 170, and the like. For example, in some implementations, aspects described herein may be implemented in the context of a disaggregated radio access network (RAN) architecture (e.g., open RAN architecture). In a disaggregated architecture, the RAN may be split into three areas of functionality corresponding to the CU 160, the DU 165, and the RU 170. The split of functionality between the CU 160, DU 165, and RU 175 is flexible and as such gives rise to numerous permutations of different functionalities depending upon which functions (e.g., MAC functions, baseband functions, radio frequency functions, and any combinations thereof) are performed at the CU 160, DU 165, and RU 175. For example, a functional split of the protocol stack may be employed between a DU 165 and an RU 170 such that the DU 165 may support one or more layers of the protocol stack and the RU 170 may support one or more different layers of the protocol stack.

Some wireless communications systems (e.g., wireless communications system 100), infrastructure and spectral resources for NR access may additionally support wireless backhaul link capabilities in supplement to wireline backhaul connections, providing an IAB network architecture. One or more base stations 105 may include CUs 160, DUs 165, and RUs 170 and may be referred to as donor base stations 105 or IAB donors. One or more DUs 165 (e.g., and/or RUs 170) associated with a donor base station 105 may be partially controlled by CUs 160 associated with the donor base station 105. The one or more donor base stations 105 (e.g., IAB donors) may be in communication with one or more additional base stations 105 (e.g., IAB nodes 104) via supported access and backhaul links. IAB nodes 104 may support mobile terminal (MT) functionality controlled and/or scheduled by DUs 165 of a coupled IAB donor. In addition, the IAB nodes 104 may include DUs 165 that support communication links with additional entities (e.g., IAB nodes 104, UEs 115, etc.) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of base stations 105. IAB donor and one or more IAB nodes 104 may be configured as (e.g., or in communication according to) some relay chain.

For instance, an access network (AN) or RAN may refer to communications between access nodes (e.g., IAB donor), IAB nodes 104, and one or more UEs 115. The IAB donor may facilitate connection between the core network 130 and the AN (e.g., via a wireline or wireless connection to the core network 130). That is, an IAB donor may refer to a RAN node with a wireline or wireless connection to core network 130. The IAB donor may include a CU 160 and at least one DU 165 (e.g., and RU 170), where the CU 160 may communicate with the core network 130 over an NG interface (e.g., some backhaul link). The CU 160 may host layer 3 (L3) (e.g., RRC, service data adaption protocol (SDAP), PDCP, etc.) functionality and signaling. The at least one DU 165 and/or RU 170 may host lower layer, such as layer 1 (L1) and layer 2 (L2) (e.g., RLC, MAC, physical (PHY), etc.) functionality and signaling, and may each be at least partially controlled by the CU 160. The DU 165 may support one or multiple different cells. IAB donor and IAB nodes 104 may communicate over an F1 interface according to some protocol that defines signaling messages (e.g., F1 AP protocol). Additionally, CU 160 may communicate with the core network over an NG interface (which may be an example of a portion of backhaul link), and may communicate with other CUs 160 (e.g., a CU 160 associated with an alternative IAB donor) over an Xn-C interface (which may be an example of a portion of a backhaul link).

IAB nodes 104 may refer to a RAN node that provides IAB functionality (e.g., access for UEs 115, wireless self-backhauling capabilities, etc.). IAB nodes 104 may include a DU 165 and an MT. A DU 165 may act as a distributed scheduling node towards child nodes associated with the IAB node 104, and the MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, an IAB node 104 may also be referred to as a parent node or a child node to other IAB nodes 104, depending on the relay chain or configuration of the AN. Therefore, the MT entity of IAB nodes 104 (e.g., MTs) may provide a Uu interface for a child node to receive signaling from a parent IAB node 104, and the DU interface (e.g., DUs 165) may provide a Uu interface for a parent node to signal to a child IAB node 104 or UE 115.

For example, IAB node 104 may be referred to a parent node associated with IAB node, and a child node associated with IAB donor. The IAB donor may include a CU 160 with a wireline (e.g., optical fiber) or wireless connection to the core network and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a base station 105 may additionally or alternatively be performed by components of the disaggregated RAN architecture (e.g., IAB nodes, DUs, CUs, etc.).

In the wireless communications system 100, a UE 115 may support wireless communications with a base station 105 or other UE 115 over a single component carrier in an unlicensed radio frequency spectrum band shared with the base station 105 or the other UE 115. In contrast to the unlicensed radio frequency spectrum band, a UE 115 operating in a licensed radio frequency spectrum band does not share the licensed radio frequency spectrum band with other UE 115 in the wireless communications system 100. Additionally or alternatively, in the wireless communications system 100, a UE 115 may support wireless communications with a base station 105 over multiple component carriers in an unlicensed radio frequency spectrum band. The UE 115 may also support wireless communications with other UEs 115, in the wireless communications system 100, over multiple component carriers in an unlicensed radio frequency spectrum band shared via sidelink communications. For example, the wireless communications system 100 may be a CV2X system. The UE 115 may thereby support CV2X operations with other UE 115 in the unlicensed radio frequency spectrum band. These CV2X operations in the unlicensed radio frequency spectrum band may be subject to regulatory-imposed channel access restrictions.

Due to these restrictions, the UE 115 (e.g., a CV2X device) may be configured to perform a channel access procedure, such as an LBT procedure prior to performing any wireless communications (e.g., uplink transmissions, sidelink transmissions) in the wireless communications system 100. For example, a UE 115 may perform an LBT procedure by sensing a channel (e.g., an uplink channel, a sidelink channel) to determine whether a component carrier is idle (i.e., not used by other UE 115) or busy (i.e., used by other UE 115) for wireless communications (e.g., uplink transmissions, sidelink transmissions). A channel sensing operation may include one or more of measuring a reference signal received power (RSRP), a reference signal received quality (RSRQ), an SNR, a signal to interference ratio (SIR), a signal to noise and interference ratio (SINR), among other examples, to determine whether a channel associated with a component carrier is idle or busy.

In some examples, if the UE 115 determines that the component carrier is idle, the UE 115 may declare the LBT procedure a success (also referred to as an LBT success event) and the UE 115 may perform the wireless communications in the wireless communications system 100. That is, uplink transmissions or sidelink transmissions are performed as originally intended by the UE 115 on the component carrier. Otherwise, if the UE 115 determines that the component carrier is busy, the UE 115 may declare the LBT procedure a failure (also referred to as an LBT failure event) and the UE 115 may refrain from transmitting (e.g., not perform) the wireless communications in the wireless communications system 100. That is, uplink transmissions or sidelink transmissions are aborted by the UE 115. Sidelink communications may refer to communications which occur over a sidelink channel.

A UE 115, for example, a CV2X device may be configured to perform an operation, as a result of an LBT failure event, which may act as a trigger for the UE 115, for example, to perform a resource reselection operation. In the wireless communications system 100, one or multiple events may be defined that trigger resource reselection, such as a re-evaluation and preemption of a resource, which may be a resource in a time domain or a frequency domain, or both, as described herein. For example, the resource may be a resource in a time domain, such as a symbol period (e.g., OFDM symbol), a mini-slot, or a slot. Alternatively, the resource may be a resource in a frequency domain, such as a subcarrier or a carrier.

The triggering of the resource reselection operation by the LBT failure event may effectively result in reattempting an LBT procedure for the wireless communications that was blocked. That is, the UE 115 may attempt a new LBT procedure for the wireless communications (e.g., uplink transmissions, sidelink transmissions) that was previously aborted due to the component carrier being busy (e.g., used by another UE 115). A UE 115 may perform wireless communications with respect to a PDB, which may define a threshold for the time (e.g., a time duration) that a packet may be delayed in the wireless communications system 100. As such, the UE 115 may reattempt an LBT procedure as long as there is sufficient time (e.g., a period) remaining in the PDB. For example, the UE 115 may be able to identify a component carrier as idle and perform wireless communications (e.g., uplink transmissions, sidelink transmissions) possibly after multiple LBT procedure reattempts as long as there is sufficient time remaining in the PDB.

In the wireless communications system 100, a UE 115 may support wireless communications with a base station 105 or other UE 115, or both, over multiple component carriers in an unlicensed radio frequency spectrum band to effectively increase an available bandwidth, and therefore a transmission rate associated with the wireless communications. In some examples, a UE 115 may support carrier aggregation to increase the available bandwidth, and thereby the transmission rate as described herein. A UE 115 may support wideband operation in the unlicensed radio frequency spectrum band by operating over multiple component carriers. In some examples, each component carrier may have a bandwidth of 20 MHz. In some other examples, each component carrier may have a bandwidth different from 20 MHz.

Some applications, such as CV2X may be low-rate, thereby using multiple component carriers might be unnecessary. However, using multiple component carriers might be helpful for improving transmission reliability, for example, in safety applications as described herein. In some cases, a UE 115 may increase a transmission reliability by duplicating the same signal (e.g., uplink transmission, sidelink transmission) over multiple component carriers or by jointly encoding a payload over the available component carriers. This duplication of the same signal may be helpful in unlicensed CV2X operations, where transmitting over multiple component carriers increases the chances of a receiving device (e.g., a base station 105 or another UE 115) receiving the transmission under sufficiently small interference activity in at least one component carrier.

Similarly to the single component carrier operation, a UE 115 may perform a channel access procedure, for an LBT procedure for multi-component carrier operation in an unlicensed radio frequency spectrum band, prior to performing any wireless communications (e.g., uplink transmissions, sidelink transmissions). In some cases, the UE 115 may be configured to perform the uplink transmissions or the sidelink transmissions on component carriers that are identified as idle based on the LBT procedure. That is, transmissions may be allowed over component carriers (e.g., if any) that are identified as idle. In some cases, the UE 115 may be configured with numerous alternative procedures for performing a channel access procedure for multiple component carriers. These procedures probe all the available component carriers to identify which of them are idle (therefore, transmissions over them is allowed) and which of them are busy (therefore, transmissions over them is not allowed).

Various aspects of the present disclosure may be independent of the actual channel access procedure, such as the actual LBT procedure used to declare a component carrier as idle (i.e., available) or busy (i.e., unavailable). An LBT failure event and an LBT success event for single component carrier operation may be extended to multi-component carrier operation in the wireless communications system 100. For example, when all component carriers are identified as busy by the UE 115, this may correspond to an LBT failure event, which may trigger a resource reselection operation by the UE 115. Alternatively, when all component carriers are identified as idle by the UE 115, this may correspond to an LBT success event, and the UE 115 may proceed with wireless communications (e.g., transmission possibly over all component carriers). However, in multi-component carrier operation, it is highly likely that not all component carriers may be identified as idle or busy. A UE 115 may be configured to determine whether to declare these cases as an LBT failure event or an LBT success event.

A UE 115 may be configured to declare an LBT failure event or an LBT success event for multi-component carrier operation according to a criterion (also referred to as transmit diversity criterion) or a criteria (also referred to as transmit diversity criteria). That is, when not all component carriers are identified as idle or busy in the wireless communications system 100, the UE 115 may determine the criterion or the criteria, as described herein, based on which an LBT failure event or an LBT success event may be declared. For various applications, such as reliability-sensitive applications, the UE 115 may be configured to declare an LBT failure event such that an LBT success event has a higher number of component carriers identified as idle (hence increased transmit diversity can be achieved) compared to other applications that have lower reliability or latency requirements. In some cases, the higher the number of component carriers targeted to be identified as idle, the more difficult it might be for the UE 115 to actually declare an LBT success event. Additionally or alternatively, the UE 115 may be configured to declare an LBT failure event, so it is not so frequent such that there is a significant chance that an LBT procedure never succeeds within a PDB.

In the wireless communications system 100, a UE 115 may include a communications manager 101 that may support efficient channel access procedures for multiple component carriers in an unlicensed radio frequency spectrum band. The communications manager 101 may be an example of aspects of a communications manager as described herein. Similarly, in the wireless communications system 100, a base station 105 may include a communications manager 102 that may support efficient channel access procedures for multiple component carriers in an unlicensed radio frequency spectrum band. The communications manager 102 may be an example of aspects of a communications manager as described herein. In the wireless communications system 100, a UE 115 may include a communications manager 103 that may support efficient channel access procedures for multiple component carriers in an unlicensed radio frequency spectrum band. The communications manager 103 may be an example of aspects of a communications manager as described herein.

A UE 115 may be configured with a number of criteria for declaring a result 255 of a channel access procedure 250 as a channel access failure. For example, the UE 115 may be configured with a number of criteria for declaring an LBT failure event for multiple component carrier operation (e.g., multi-component carrier CV2X operation) in an unlicensed radio frequency spectrum band. A UE 115 may experience improvements in CV2X operation over more than one standalone unlicensed component carrier according to the techniques described herein. For example, the UE 115 may experience increased transmission reliability, which may be important in CV2X applications (e.g., such as transmission of safety messages including traffic information, roadside hazards, etc.).

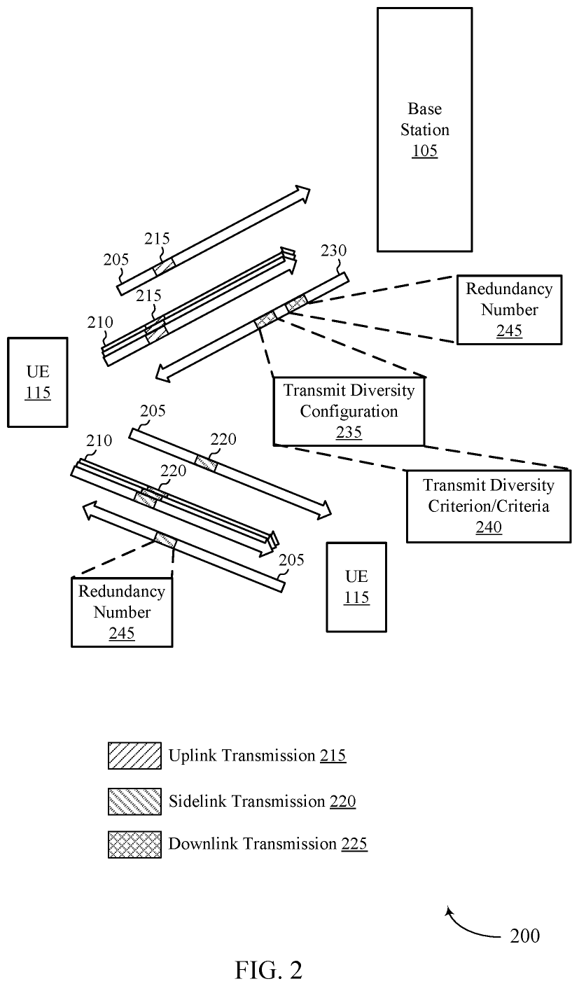

FIG. 2 illustrates an example of a wireless communications system 200 that supports performing a channel access procedure on multiple component carriers in a shared radio frequency spectrum band in accordance with one or more aspects of the present disclosure. In some examples, the wireless communications system 200 may implement aspects of the wireless communications system 100 or may be implemented by aspects of the wireless communications system 100. For example, the wireless communications system 200 may include a base station 105 and one or more UE 115. The base station 105 and the one or more UE 115 may be examples of the corresponding devices described with reference to FIG. 1. In some examples, the wireless communications system 200 may support multiple radio access technologies including 4G systems such as LTE systems, LTE-A systems, or LTE-A Pro systems, and 5G systems which may be referred to as NR systems.

The base station 105 and the one or more UE 115 may be configured with multiple antennas, which may be used to employ techniques such as transmit diversity, receive diversity, multiple-input multiple-output communications, or beamforming, or any combination thereof. The antennas of the base station 105 and the one or more UE 115 may be located within one or more antenna arrays or antenna panels, which may support multiple-input multiple-output operations or transmit or receive beamforming. For example, the base station 105 may have an antenna array with a number of rows and columns of antenna ports that the base station 105 may use to support beamforming of communications with the one or more UE 115. Likewise, the one or more UE 115 may have one or more antenna arrays that may support various multiple-input multiple-output or beamforming operations. The base station 105 and the UE 115 may thus be configured to support directional communications using the multiple antennas. A UE 115 may also support sidelink communications with another UE 115, for example, using D2D communications and vehicle-based communications, which may also be referred to as V2X communications, V2V communications, C-V2X communications, and the like.

As described herein, a UE 115 may support wireless communications with a base station 105 or another UE 115 over a single component carrier 205 or multiple component carriers 210 in an unlicensed radio frequency spectrum band to effectively increase an available bandwidth, and therefore a transmission rate associated with the wireless communications. For example, a UE 115 may transmit wireless communications to the base station 105 in the wireless communications system 200 using a single component carrier 205 or multiple component carriers 210 in an unlicensed radio frequency spectrum band. Additionally or alternatively, a UE 115 may transmit sidelink communications to another UE 115 in the wireless communications system 200 using a single component carrier 205 or multiple component carriers 210 in an unlicensed radio frequency spectrum band. As described herein, wireless communications (e.g., uplink transmission 215, sidelink transmission 220) in the unlicensed radio frequency spectrum band may be subject to regulatory-imposed channel access restrictions. As such, a UE 115 may be configured to perform a channel access procedure 250, such as an LBT procedure prior performing the wireless communications.

A UE 115 may be configured to declare an LBT failure event or an LBT success event for multi-component carrier operation according to a criterion or a criteria. That is, when not all component carriers are identified as idle or busy, a UE 115 may determine the criterion or the criteria, as described herein, based on which an LBT failure event or an LBT success event may be declared. For example, a UE 115 may be configured with a number of criteria for declaring an LBT failure event for multiple component carrier operation (e.g., multi-component carrier CV2X operation) in the unlicensed radio frequency spectrum band. A UE 115 may experience improvements in operation (e.g., CV2X operation) over more than one standalone unlicensed component carrier according to the techniques described herein. For example, a UE 115 may experience increased transmission reliability, which may be important in CV2X applications (e.g., such as transmission of safety messages including traffic information, roadside hazards, etc.).

In the example of FIG. 2, the base station 105 may transmit a downlink transmission 225 (e.g., on a single component carrier 230 or multiple component carriers (not shown)) a transmit diversity configuration 235, which may include an indication of a transmit diversity criterion/criteria 240 for declaring a result 255 of a channel access procedure 250 for a set of component carriers, for example, including the component carrier 205 and the component carriers 210 in the shared radio frequency spectrum band. An indication may refer to the transmit diversity criterion/criteria 240 itself or one or more bits corresponding to the transmit diversity criterion/criteria 240. For example, a UE 115 may be configured (e.g., scheduled, allocated) to determine a total number of component carriers for wireless operations (e.g., CV2X operations), where the total number of component carriers is defined as N, which may be an value greater than or equal to 2 component carriers (i.e., N≥2 component carriers).

The UE 115 may be configured to perform a channel access procedure 250 on the total number of component carriers N each time the UE 115 is enabled to perform wireless communications in the wireless communications system 200. For example, a CV2X device may determine that there are a total number of N≥2 component carriers available for CV2X operation that are sensed each time when the CV2X device wants to perform a transmission in the wireless communications system 200. The UE 115 may also be configured to determine a target number of component carriers to support wireless operations, where the target number of component carriers is defined as M. For example, a UE 115 may be configured to determine a minimum number of component carriers M (also referred to as a target transmit diversity number of component carriers) to support the wireless operations, where M is a value greater than or equal to one (i.e., M≥1) and the value for M is less than or equal to N (i.e., M≤N). A UE 115 may also be configured to determine a number of available (e.g., idle) component carriers (e.g., not used by other UE 115 in the wireless communications system 200), where the number of available component carriers is defined as N′, where N′ may have a value greater than or equal to zero (N′≥0) and less than or equal to N (N′≤N).

In some cases, a UE 115 may determine that the number of available component carriers N′ is less than the target number of component carriers M (i.e., N′≤M) to support the wireless communications (e.g., uplink transmission 215, sidelink transmission 220). In this case, the UE 115 may be configured to declare the LBT procedure as an LBT failure event. For example, if the uplink transmission 215 or the sidelink transmission 220 requires at least (i.e., minimum) 2 component carriers (e.g., M=2 component carriers), the UE 115 may declare an LBT failure event if the number of component carriers identified as idle is zero (e.g., N′=0 or N′=1).

In some other cases, a UE 115 may declare an LBT failure event when a number of conditions (also referred to as one or more criteria) are satisfied. That is, even though a target (e.g., minimum) number of resources for the uplink transmission 215 or the sidelink transmission 220 are available (e.g., N′≥M), a UE 115 may declare an LBT failure event. The UE 115 may then trigger, for example, a resource reselection operation and reattempt the LBT procedure. In some examples, a condition may be that a UE 115 does not render an LBT failure event. That is, a UE 115 may proceed with the wireless communications (e.g., the uplink transmission 215, the sidelink transmission 220) as long as the resources targeted to support the communications are found available. For example, if the uplink transmission 215 or the sidelink transmission 220 needs one component carrier, a UE 115 may proceed with the transmission if at least one component carrier is identified as idle. In some other examples, a condition may be that a UE 115 renders an LBT failure event based on the UE 115 determining that the number of available component carriers N′ is less than a multiple of the target number of component carriers M (i.e., N′≤x·M) required to support the uplink transmission 215 or the sidelink transmission 220, where x is a redundancy number.

A UE 115 may declare an LBT failure event when N′≥M based on one or more conditions. That is, a UE 115 may declare an LBT failure event even though enough CCs may be available for a transmission. In some examples, the redundancy number x may be configured to have a value greater than or equal to one (x≥1). The multiple of the target number of component carriers M may be configured to be less than or equal to the total number of component carriers (x·M is less than or equal to N (i.e., x·M≤N)). By way of example, a UE 115 may determine that a target number of component carriers M for the uplink transmission 215 or the sidelink transmission 220 is one component carrier (i.e., M=1). For the uplink transmission 215 or the sidelink transmission 220, the redundancy number x may be 2 (i.e., x=2) assuming that the total number of component carriers N for wireless operations (e.g., CV2X operations) is greater than or equal to 2 component carriers (i.e., N≥2 component carriers) used by the wireless communications system 200. As such, if the UE 115 determines zero number of component carriers N′ as idle (i.e., N′=0) or a single component carrier N′ as idle (i.e., N′=1) based on an LBT procedure, the UE 115 may declare a result of the LBT procedure as an LBT failure event and reattempt the LBT procedure. The UE 115 may declare the result of the LBT procedure, for example, after a resource reselection (e.g., selection of other component carriers, etc.). Therefore, when the uplink transmission 215 or the sidelink transmission 220 are to be performed there will be at least x times the minimum number of component carriers M available. For the example above, the uplink transmission 215 or the sidelink transmission 220 may be performed by the UE 115 as long as at least 2 component carriers are idle.

By allowing transmissions (e.g., the uplink transmission 215 or the sidelink transmission 220) when N′ is greater than M, (e.g., N′>x·M where x is greater than one) may result in greater transmit diversity in the wireless communications system 200. In some examples, a UE 115 may exploit the redundant component carriers to increase a transmission reliability (e.g., by duplicating or jointly encoding over the available component carriers). In some other examples, a UE 115 may select M out of the N′ component carriers for a transmission (e.g., the uplink transmission 215 or the sidelink transmission 220), which may reduce the probability of collisions with other UE 115 that performed an LBT procedure at the same time and identified the same component carriers as idle. For example, when N′=M=1, it is very likely that another close-by UE 115 that performed an LBT procedure at the same time may identify the same single component carrier as idle. Both UEs 115 may proceed in transmitting over the same component carrier, with increased likelihood of collision in the wireless communications system 200. Alternatively, if transmissions are allowed when at least 2 component carriers are identified as idle (i.e., N′=2 component carriers), and each UE 115 selects one of them for its transmission (e.g., randomly), the probability of the two UE 115 selecting the same component carrier and colliding is reduced.

In the wireless communications system 200, a UE 115 may be configured or preconfigured with the redundancy number x. In some examples, the redundancy number x may be specified in a wireless specification with which a UE 115 complies. In some other examples, the redundancy number x may be indicated to a UE 115 by the network (e.g., the base, station 105) via signaling. For example, the base station 105 may configure a UE 115 with the redundancy number x as part of the transmit diversity configuration 235 or separately via semi-static signaling or dynamic signaling. For example, the base station 105 may transmit, to a UE 115, an RRC configuration message, which may include an indication of the redundancy number x. The RRC configuration message may be an example of semi-static signaling. Alternatively, the base station 105 may transmit, to a UE 115, a MAC-CE message (also referred to as MAC-CE) or a DCI message, which may include an indication of the redundancy number x. The MAC-CE message and the DCI message may be examples of dynamic signaling.

In some examples, the redundancy number x may be applicable for all types of wireless communications in the wireless communications system 200. That is, the redundancy number x may be configured or preconfigured system-wide, in the wireless communications system 200, to be the same for all types of transmissions. For example, the redundancy number x may be the same for the uplink transmission 215 and the sidelink transmission 220. Alternatively or additionally, the redundancy number x may be different for different types of transmissions. For example, there may be different redundancy numbers x for the uplink transmission 215 and the sidelink transmission 220. In some other examples, the redundancy number x may depend on transmission specific parameters. That is, the redundancy number x may be configured or preconfigured system-wide, in the wireless communications system 200, to depend on transmission specific parameters. For example, a UE 115 may determine a redundancy number x for the uplink transmission 215 or the sidelink transmission 220 based on a type of application associated with the uplink transmission 215 or the sidelink transmission 220. The type of application may be a CV2X application, an ultra-reliable and low latency (URLL) application, among other examples. By implementing the redundancy number x to depend on transmission specific parameters, transmissions, such as the uplink transmission 215 or the sidelink transmission 220 corresponding to applications targeting high reliability might have a greater redundancy number x in order to achieve greater transmit diversity.

A UE 115 may also determine a redundancy number x for the uplink transmission 215 or the sidelink transmission 220 based on a PDB, for example, associated with a channel access procedure 250, such as an LBT procedure. By implementing the redundancy number x to depend on transmission specific parameters, transmissions, such as the uplink transmission 215 or the sidelink transmission 220 with small PDB might have a smaller redundancy number x (possibly, equal to 1), since these transmissions might not be able to afford many LBT attempts before the PDB expires and it is easier to identify a smaller number of component carriers as idle. Additionally or alternatively, a UE 115 may determine a redundancy number x for the uplink transmission 215 or the sidelink transmission 220 based on the minimum number of required component carriers M available for the transmission. By implementing the redundancy number x to depend on transmission specific parameters, transmissions, such as the uplink transmission 215 or the sidelink transmission 220 with a smaller minimum number of required component carriers M available can afford a larger redundancy number x, because identifying N′=x·M component carriers as idle for a greater minimum number of component carriers M is more difficult for a UE 115.

In the example of FIG. 2, the notion of a large redundancy number x and a small redundancy number x is to be understood as relative to M and N values. In some examples, a redundancy number x value of 3 for a minimum number of component carriers M value of 1 and a total number of component carriers N value of 4 may be considered as a large redundancy number. In some other examples, a redundancy number x value of 4 for a minimum number of component carriers M value of 1 and a total number of component carriers N value of 10 may be considered as a small redundancy number. As such, the total number of component carriers N available also contributes to determining a value for the redundancy number x.

A UE 115 may determine a redundancy number x for the uplink transmission 215 or the sidelink transmission 220 based on a time-varying aspect. That is, a value of the redundancy number x may be time-varying, possibly changing between successive LBT attempts for the same transmission. By way of example, for a channel access procedure attempt (e.g., a first LBT procedure attempt) of a packet for the uplink transmission 215 or the sidelink transmission 220, a UE 115 may select a large value for a redundancy number x assuming that a PDB is large enough to allow for a sufficient number of channel access procedure attempts (e.g., LBT procedure attempts). As the PDB is about to expire and the channel access procedure 250 (e.g., LBT procedure) keeps failing, the UE 115 may reduce a value of the redundancy number x, in order to increase the chance of the channel access procedure 250 (e.g., LBT procedure) succeeding prior to the PDB (even with minimum or no transmit diversity).

A UE 115 may determine a redundancy number x for the uplink transmission 215 or the sidelink transmission 220 based on interference activity measured by the network (e.g., the base station 105). Under small interference activity, a greater value for the redundancy number x may be afforded since it is easier to identify a larger number of available component carriers N′ (i.e., identified as idle). However, under large interference activity, a smaller value for the redundancy number x might be preferable, since it is difficult to identify a larger number of component carriers N′ (i.e., identified as idle). In some examples, the network, the UE 115, or both, may perform real-time measurements of interference activity on the one or more component carriers, in the wireless communications system 200 and adjust a value of the redundancy number x. For example, the base station 105 may perform measurements of interference activity on one or more component carriers in the unlicensed (e.g., shared) band in the wireless communications system 200, adjust a value of the redundancy number x based on these measurements, and signal to one or more of the UE 115 the adjusted value of the redundancy number x (e.g., the redundancy number 245), for example, via the downlink transmission 225. The signaling may include RRC signaling, MAC-CE signaling, or DCI signaling, or a combination thereof. In some examples, the base station 105 may update a criterion including the redundancy number x and communicate in a message (e.g., an RRC message, a DCI message, etc.) with the updated criterion (e.g., the redundancy number x) for declaring a result of an LBT procedure. Additionally or alternatively, a UE 115 (e.g., a neighboring UE) may perform measurements of interference activity on one or more component carriers in the unlicensed (e.g., shared) band in the wireless communications system 200, adjust a value of the redundancy number x based on these measurements, and signal to the UE 115 the adjusted value of the redundancy number x (e.g., the redundancy number 245), for example, via the sidelink transmission 220.

Additionally or alternatively, a UE 115 may determine a redundancy number x for the uplink transmission 215 or the sidelink transmission 220 based on interference activity measured by the UE 115. For example, a UE 115 may determine it operates in high interference conditions and may identify that the number of available component carriers N′ is equal to the target number of component carriers M for a transmission (e.g., the uplink transmission 215, the sidelink transmission 220). That is, N′=M component carriers as idle to proceed with the transmission, and thereby the value of the redundancy number x is equal to 1 (x=1). The UE 115 may perform the above instead of taking the chance to aim for a larger N′ (x≥1) that may not happen prior the PDB expiring. A UE 115 may determine interference information based on determining a channel busy ratio (CBR) in the wireless communications system 200. For example, a UE 115 may determine the CBR based on identifying a received signal strength indicator (RSSI) according to measuring one or more reference signals in the wireless communications system 200.

In some other examples, a UE 115 may determine interference information based on a channel access procedure history (e.g., an LBT history). For example, based on previous LBT attempts, the UE 115 may have information on how many component carriers are more likely to be identified as idle and sets a value of the redundancy number x accordingly. As such, a UE 115 uses its previous experience regarding channel access and adjusts the current value of the redundancy number x accordingly. For example, if a UE 115 previously experienced multiple LBT failures with a value of the redundancy number x equal to 3 (e.g., x=3), the UE 115 might select to change the value of the redundancy number x to 2 (e.g., x=2) for its following LBT attempts as a smaller value of the redundancy number x may prompt an LBT success more probable.

A UE 115 may determine a result 255 of a channel access procedure 250, such as an LBT procedure based on a probability model. For example, when N′ component carriers are identified as idle, a UE 115 may declare a result of an LBT procedure as LBT failure event with the following probability 0≤p(N′)≤1, where N′=0, 1, . . . , N. In some cases, the probability model may correspond to a degenerate probability mass function (PMF). In some examples, a UE 115 may declare a result of an LBT procedure as an LBT failure event with the following probability p(N′)=1, for all N′≤x·M. In some other examples, a UE 115 may declare a result of an LBT procedure as an LBT failure event with the following probability p(N)=0, for all N≥x·M. The PMF may depend on all parameters described herein, and be system-wide configured or indicated or computed independently per device (e.g., the base station 105, the UE 115).

Therefore, in the wireless communications system 200, a criteria for declaring a result 255 of a channel access procedure 250, for example, an LBT success event or an LBT failure event in multi-component carrier unlicensed operation (e.g., multi-component carrier unlicensed CV2X operation) is described. The criteria are designed towards reliability-sensitive (e.g., safety) applications where a greater number of component carriers may enhance transmit diversity. These criteria consider CV2X-specific aspects such as PDB and packet priority towards optimally identifying and adjusting the targeted number of idle component carriers.

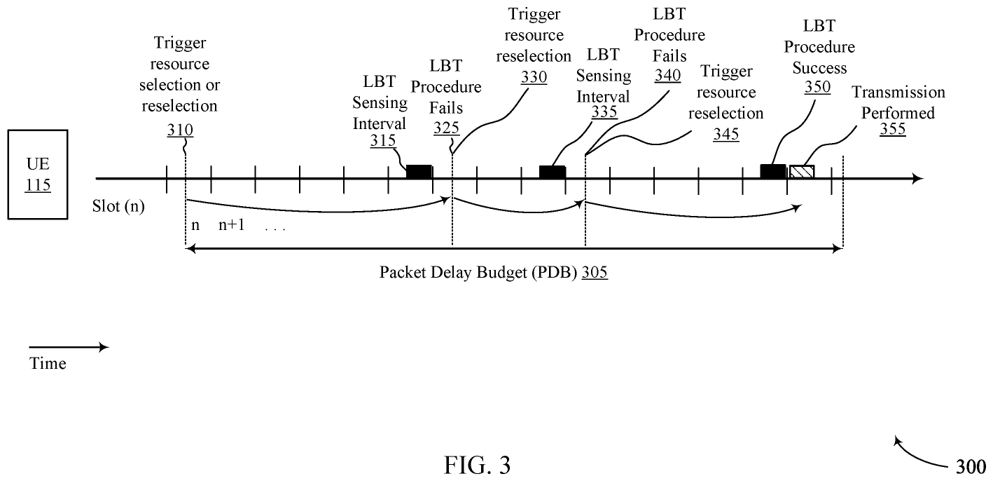

FIG. 3 illustrates an example of a transmission scheme 300 that supports performing a channel access procedure on multiple component carriers in a shared radio frequency spectrum band in accordance with one or more aspects of the present disclosure. The transmission scheme 300 may be implemented by aspects of the wireless communications systems 100 and 200 or may implement aspects of the wireless communications systems 100 and 200 as described with reference to FIGS. 1 and 2, respectively. For example, the transmission scheme 300 may be implemented by a UE 115, as described with reference to FIGS. 1 and 2. The transmission scheme 300 may be implemented by the UE 115 to support efficient channel access procedures for multiple component carriers in an unlicensed radio frequency spectrum band.

In the example of FIG. 3, a UE 115 may perform a channel access procedure, such as an LBT procedure for multiple component carriers in an unlicensed radio frequency spectrum band prior to performing any wireless communications (e.g., an uplink transmission, a sidelink transmission). The LBT procedure may be associated with a PDB 305. At 310, the UE 115 may trigger a resource selection or reselection as described herein, which may be selected within the PDB 305. The UE 115 may perform channel sensing associated with the multiple component carriers in the unlicensed radio frequency spectrum band during an LBT sensing interval 315. At 325, the UE 115 may declare a result of the LBT procedure as an LBT failure event, for example, based on one or more aspects described herein.

At 330, the UE 115 may trigger resource reselection to reattempt the LBT procedure. For example, the UE 115 may again perform channel sensing associated with the multiple component carriers in the unlicensed radio frequency spectrum band during an LBT sensing interval 335. At 340, the UE 115 may again declare a result of the LBT procedure as an LBT failure event, for example, based on one or more aspects described herein, and at 345 trigger a resource reselection to reattempt the LBT procedure. At 350, the UE 115 may again perform channel sensing associated with the multiple component carriers in the unlicensed radio frequency spectrum band during an LBT sensing interval. This time, the UE 115 declare a result of the LBT procedure as an LBT success event, for example, based on one or more aspects described herein. Therefore, as long as there is sufficient remaining time in the PDB 305, the UE 115 may be able to identify a channel as idle and perform a transmission (e.g., possibly after multiple LBT attempts).

At 355, the UE 115 may perform the wireless communications (e.g., an uplink transmission, a sidelink transmission). For example, the UE 115 may transmit wireless communications (e.g., an uplink transmission, a sidelink transmission) using one or more time resources (e.g., a symbol duration, a minislot duration, a slot duration, a subframe duration, a frame duration), as well as frequency resources (e.g., subcarriers, carriers) for a physical uplink channel, such as a physical uplink control channel (PUCCH). In some other examples, a UE 115 may transmit the wireless communications (e.g., an uplink transmission, a sidelink transmission) using one or more time resources (e.g., a symbol duration, a minislot duration, a slot duration, a subframe duration, a frame duration), as well as frequency resources (e.g., subcarriers, carriers) for a physical uplink channel, such as a physical uplink shared channel (PUSCH). In other examples, the UE 115 may transmit wireless communications (e.g., an uplink transmission, a sidelink transmission) using one or more time resources (e.g., a symbol duration, a minislot duration, a slot duration, a subframe duration, a frame duration), as well as frequency resources (e.g., subcarriers, carriers) for a physical sidelink control channel (PSCCH) or a physical sidelink shared channel (PSSCH), or both.

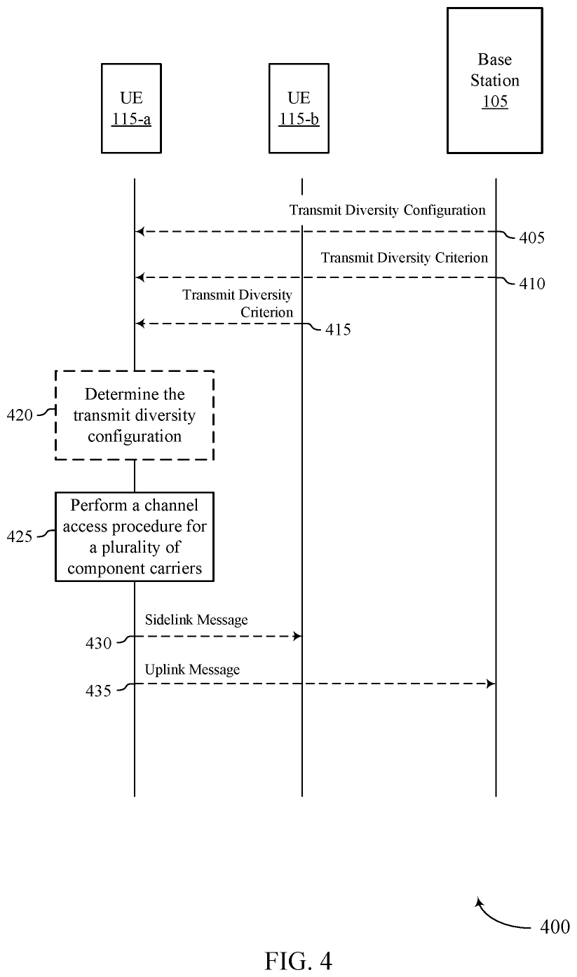

FIG. 4 illustrates an example of a process flow 400 that supports performing a channel access procedure on multiple component carriers in a shared radio frequency spectrum band in accordance with one or more aspects of the present disclosure. The process flow 400 may implement be implemented by aspects of the wireless communications systems 100 and 200 or may aspects of the wireless communications system 100 and 200 described with reference to FIGS. 1 and 2, respectively. For example, the process flow 400 may be based on a configuration by a base station 105 or a UE 115, and implemented by the UE 115. The base station 105 and the UE 115 may be examples of devices, as described herein. In the following description of the process flow 400, the operations between the base station 105 and the UE 115 may be transmitted in a different order than the example order shown, or the operations performed by the base station 105 and the UE 115 may be performed in different orders or at different times. Some operations may also be omitted from the process flow 400, and other operations may be added to the process flow 400.

At 405, the base station 105 may transmit a transmit diversity configuration to the UE 115-a. The transmit diversity configuration may indicate a transmit diversity criterion for declaring a result of a channel access procedure for a plurality of component carriers in a shared radio frequency spectrum band as described herein. At 410, the base station 105 may transmit a transmit diversity criterion separately for declaring the result of the channel access procedure for the plurality of component carriers in the shared radio frequency spectrum band based at least in part on an observed interference level at the base station 105 satisfying a threshold. As described herein, a threshold may refer to a value in which observed values are compared to for deciding. Additionally or alternatively, at 415, the UE 115-b may transmit a transmit diversity criterion separately for declaring the result of the channel access procedure for the plurality of component carriers in the shared radio frequency spectrum band based at least in part on an observed interference level at the UE 115-b satisfying a threshold.

At 420, the UE 115-a may determine the transmit diversity configuration. For example, the UE 115-a may be preconfigured with the transmit diversity configuration or may determine the configuration based on receiving the configuration from the base station 105 or the UE 115-b, or both. At 425, the UE 115-a may perform a channel access procedure (e.g., an LBT procedure) for a plurality of component carriers as described herein. The UE 115-a may perform a channel access procedure (e.g., an LBT procedure) for a plurality of component carriers to determine the result of the channel access procedure based at least in part on the transmit diversity criterion. At 430, the UE 115-a may transmit a sidelink message to the UE 115-b based at least in part on the result of the channel access procedure. Additionally or alternatively, at 435, the UE 115-a may transmit an uplink message to the base station 105 based at least in part on the result of the channel access procedure.

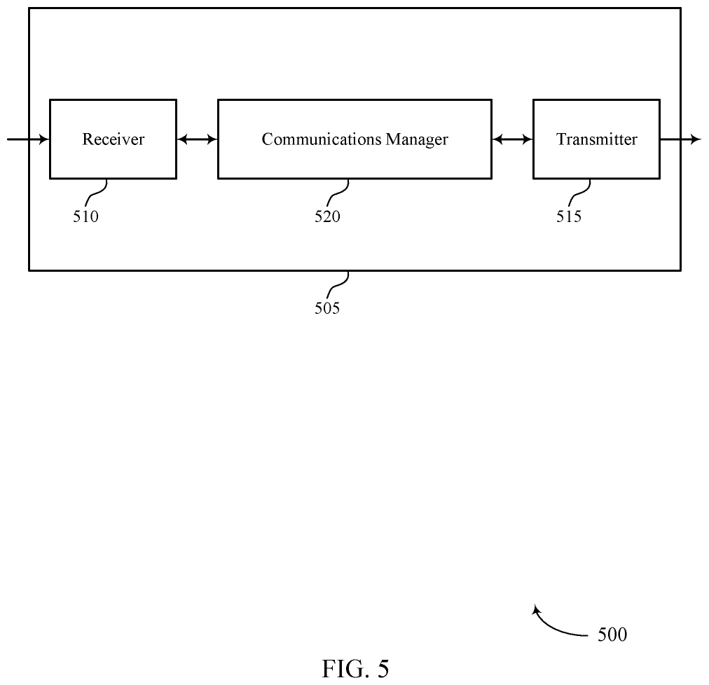

FIG. 5 shows a block diagram 500 of a device 505 that supports performing a channel access procedure on multiple component carriers in a shared radio frequency spectrum band in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to performing a channel access procedure on multiple component carriers in a shared radio frequency spectrum band). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to performing a channel access procedure on multiple component carriers in a shared radio frequency spectrum band). In some examples, the transmitter 515 may be co-located with a receiver 510 in a transceiver component. The transmitter 515 may utilize a single antenna or a set of multiple antennas.

The communications manager 520, the receiver 510, the transmitter 515, or various combinations thereof or various components thereof may be examples of means for performing various aspects of performing a channel access procedure on multiple component carriers in a shared radio frequency spectrum band as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support multicarrier wireless communication at a first UE in a wireless communications system in accordance with examples as disclosed herein. For example, the communications manager 520 may be configured as or otherwise support a means for determining a transmit diversity configuration indicating a transmit diversity criterion for declaring a result of a channel access procedure for a set of multiple component carriers in a shared radio frequency spectrum band. The communications manager 520 may be configured as or otherwise support a means for performing the channel access procedure for the set of multiple component carriers in the shared radio frequency spectrum band to determine the result of the channel access procedure based on the transmit diversity criterion. The communications manager 520 may be configured as or otherwise support a means for transmitting or refraining from transmitting a message over at least one component carrier of the set of multiple component carriers based on the result of the channel access procedure.

Additionally or alternatively, the communications manager 520 may support wireless communication at a first UE in accordance with examples as disclosed herein. For example, the communications manager 520 may be configured as or otherwise support a means for measuring one or more sidelink reference signals to determine an observed interference level at the first UE. The communications manager 520 may be configured as or otherwise support a means for communicating, to a second UE, a message including an indication of a transmit diversity criterion for declaring a result of a channel access procedure for a set of multiple component carriers in a shared radio frequency spectrum band based on the observed interference level satisfying a threshold.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced power consumption, more efficient utilization of communication resources by support efficient channel access procedures for multiple component carriers in a shared radio frequency spectrum band.

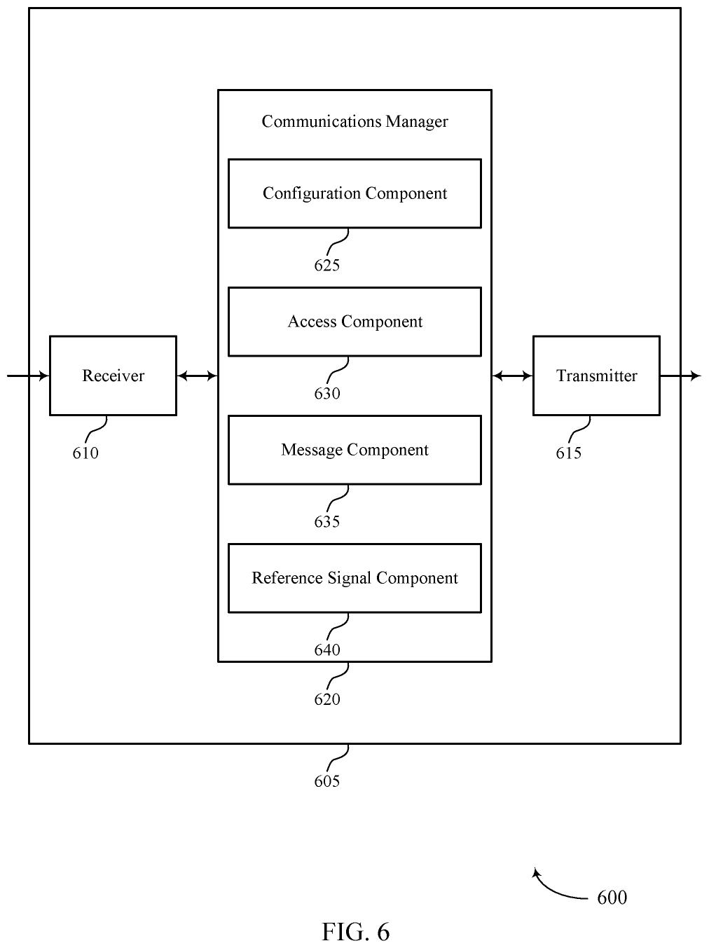

FIG. 6 shows a block diagram 600 of a device 605 that supports performing a channel access procedure on multiple component carriers in a shared radio frequency spectrum band in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to performing a channel access procedure on multiple component carriers in a shared radio frequency spectrum band). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to performing a channel access procedure on multiple component carriers in a shared radio frequency spectrum band). In some examples, the transmitter 615 may be co-located with a receiver 610 in a transceiver component. The transmitter 615 may utilize a single antenna or a set of multiple antennas.

The device 605, or various components thereof, may be an example of means for performing various aspects of performing a channel access procedure on multiple component carriers in a shared radio frequency spectrum band as described herein. For example, the communications manager 620 may include a configuration component 625, an access component 630, a message component 635, a reference signal component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support multicarrier wireless communication at a first UE in a wireless communications system in accordance with examples as disclosed herein. The configuration component 625 may be configured as or otherwise support a means for determining a transmit diversity configuration indicating a transmit diversity criterion for declaring a result of a channel access procedure for a set of multiple component carriers in a shared radio frequency spectrum band. The access component 630 may be configured as or otherwise support a means for performing the channel access procedure for the set of multiple component carriers in the shared radio frequency spectrum band to determine the result of the channel access procedure based on the transmit diversity criterion. The message component 635 may be configured as or otherwise support a means for transmitting or refraining from transmitting a message over at least one component carrier of the set of multiple component carriers based on the result of the channel access procedure.

Additionally or alternatively, the communications manager 620 may support wireless communication at a first UE in accordance with examples as disclosed herein. The reference signal component 640 may be configured as or otherwise support a means for measuring one or more sidelink reference signals to determine an observed interference level at the first UE. The message component 635 may be configured as or otherwise support a means for communicating, to a second UE, a message including an indication of a transmit diversity criterion for declaring a result of a channel access procedure for a set of multiple component carriers in a shared radio frequency spectrum band based on the observed interference level satisfying a threshold.

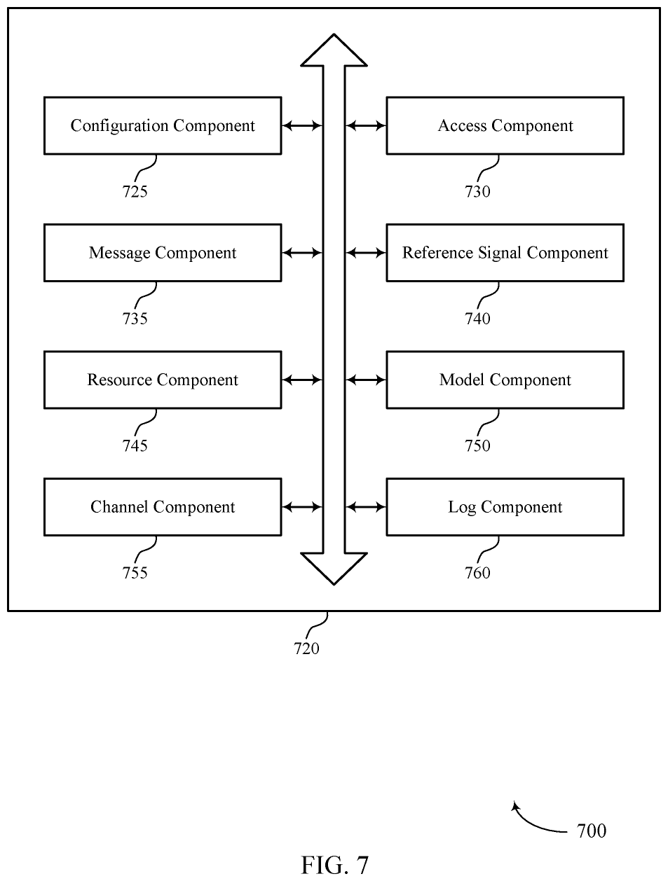

FIG. 7 shows a block diagram 700 of a communications manager 720 that supports performing a channel access procedure on multiple component carriers in a shared radio frequency spectrum band in accordance with one or more aspects of the present disclosure. The communications manager 720 may be an example of aspects of a communications manager 520, a communications manager 620, or both, as described herein. The communications manager 720, or various components thereof, may be an example of means for performing various aspects of performing a channel access procedure on multiple component carriers in a shared radio frequency spectrum band as described herein. For example, the communications manager 720 may include a configuration component 725, an access component 730, a message component 735, a reference signal component 740, a resource component 745, a model component 750, a channel component 755, a log component 760, or any combination thereof. Each of these components may communicate, directly or indirectly, with one another (e.g., via one or more buses).

The communications manager 720 may support multicarrier wireless communication at a first UE in a wireless communications system in accordance with examples as disclosed herein. The configuration component 725 may be configured as or otherwise support a means for determining a transmit diversity configuration indicating a transmit diversity criterion for declaring a result of a channel access procedure for a set of multiple component carriers in a shared radio frequency spectrum band. The access component 730 may be configured as or otherwise support a means for performing the channel access procedure for the set of multiple component carriers in the shared radio frequency spectrum band to determine the result of the channel access procedure based on the transmit diversity criterion. The message component 735 may be configured as or otherwise support a means for transmitting or refraining from transmitting a message over at least one component carrier of the set of multiple component carriers based on the result of the channel access procedure.

In some examples, the message component 735 may be configured as or otherwise support a means for receiving a control message indicating the transmit diversity configuration, where the control message includes an RRC message, a MAC-CE message, or a DCI message, or a combination thereof. In some examples, the configuration component 725 may be configured as or otherwise support a means for receiving, from a second UE or a node, an indication of the transmit diversity criterion for declaring the result of the channel access procedure for the set of multiple component carriers in the shared radio frequency spectrum band based on an observed interference level satisfying a threshold.

The configuration component 725 may be configured as or otherwise support a means for receiving the transmit diversity configuration indicating a redundancy number. In some examples, the message component 735 may be configured as or otherwise support a means for transmitting or refraining from transmitting the message over the at least one component carrier of the set of multiple component carriers based on the redundancy number. The message component 735 may be configured as or otherwise support a means for transmitting or refraining from transmitting the message over the at least one component carrier of the set of multiple component carriers based on a transmit diversity threshold number, where the transmit diversity threshold number is a product of a redundancy number and a target transmit diversity number of component carriers specified for transmission of the message. In some examples, the redundancy number is greater than or equal to one. In some examples, the product of the redundancy number and the target transmit diversity number is less than or equal to a total number of the set of multiple component carriers. In some examples, the transmit diversity threshold number is a multiple of the target transmit diversity number. In some examples, the redundancy number is preconfigured.

In some examples, the redundancy number is based on a type of application of the message. In some examples, the redundancy number is based on the total number of component carriers in the wireless communications system. In some examples, the redundancy number is based on a PDB associated with the channel access procedure. In some examples, the redundancy number is based on a period when the channel access procedure is performed and a PDB associated with the channel access procedure. In some examples, the redundancy number is based on a defined number of component carriers specified for the message. In some examples, the redundancy number is determined based on interference information for one or more component carriers of the set of multiple component carriers.

The channel component 755 may be configured as or otherwise support a means for receiving the interference information from a node in wireless communication with the first UE, or a second UE in sidelink communication with the first UE, or both. In some examples, the message component 735 may be configured as or otherwise support a means for transmitting or refraining from transmitting the message over the at least one component carrier of the set of multiple component carriers based on the interference information. In some examples, the channel component 755 may be configured as or otherwise support a means for determining a CBR based on measuring one or more reference signals communicated via the one or more component carriers of the set of multiple component carriers, the interference information including the CBR.

The log component 760 may be configured as or otherwise support a means for determining a set of multiple previous results of a set of multiple previous channel access procedures performed by the first UE. In some examples, the resource component 745 may be configured as or otherwise support a means for estimating that the one or more component carriers of the set of multiple component carriers are available for transmission of the message based on the set of multiple previous results of the set of multiple previous channel access procedures performed by the first UE. The redundancy number is determined based on the estimated one or more component carriers of the set of multiple component carriers that are available for transmission of the message.

In some examples, the resource component 745 may be configured as or otherwise support a means for determining one or more component carriers of the set of multiple component carriers are available for transmission of the message based on the channel access procedure. In some examples, the access component 730 may be configured as or otherwise support a means for declaring the result as a channel access failure based on a number of the one or more component carriers satisfying a transmit diversity threshold number specified in the transmit diversity criterion. The number of one or more component carriers are available for transmission of the message. In some examples, the message component 735 may be configured as or otherwise support a means for refraining from transmitting the message based on the channel access failure.

The resource component 745 may be configured as or otherwise support a means for determining one or more component carriers of the set of multiple component carriers are available for transmission of the message based on the channel access procedure. In some examples, the access component 730 may be configured as or otherwise support a means for declaring the result as a channel access success based on a number of the one or more component carriers satisfying a transmit diversity threshold number specified in the transmit diversity criterion, where the number of one or more component carriers are available for transmission of the message. In some examples, the message component 735 may be configured as or otherwise support a means for transmitting the message on the one or more component carriers based on declaring the result the channel access success. In some examples, the model component 750 may be configured as or otherwise support a means for determining a probability of the result of the channel access procedure using a probability model. In some examples, the access component 730 may be configured as or otherwise support a means for declaring the result of the channel access procedure for based on the probability.

Additionally or alternatively, the communications manager 720 may support wireless communication at a first UE in accordance with examples as disclosed herein. The reference signal component 740 may be configured as or otherwise support a means for measuring one or more sidelink reference signals to determine an observed interference level at the first UE. In some examples, the message component 735 may be configured as or otherwise support a means for communicating, to a second UE, a message including an indication of a transmit diversity criterion for declaring a result of a channel access procedure for a set of multiple component carriers in a shared radio frequency spectrum band based on the observed interference level satisfying a threshold.

In some examples, to support communicating the message, the message component 735 may be configured as or otherwise support a means for communicating the message including the indication of the transmit diversity criterion that specifies a transmit diversity threshold number for declaring the result as a channel access failure based on a number of one or more component carriers satisfying the transmit diversity threshold number specified in the transmit diversity criterion. The number of one or more component carriers are available for transmission. In some examples, to support communicating the message, the message component 735 may be configured as or otherwise support a means for communicating the message including the indication of the transmit diversity criterion that specifies a transmit diversity threshold number for declaring the result as a channel access success based on a number of one or more component carriers satisfying the transmit diversity threshold number specified in the transmit diversity criterion. The number of one or more component carriers are available for transmission.

In some examples, to support communicating the message, the message component 735 may be configured as or otherwise support a means for communicating the message including the indication of the transmit diversity criterion that specifies a transmit diversity threshold number that is a product of a redundancy number and a target transmit diversity number of component carriers. In some examples, the redundancy number is greater than one. In some examples, the transmit diversity threshold number is a multiple of the target transmit diversity number.

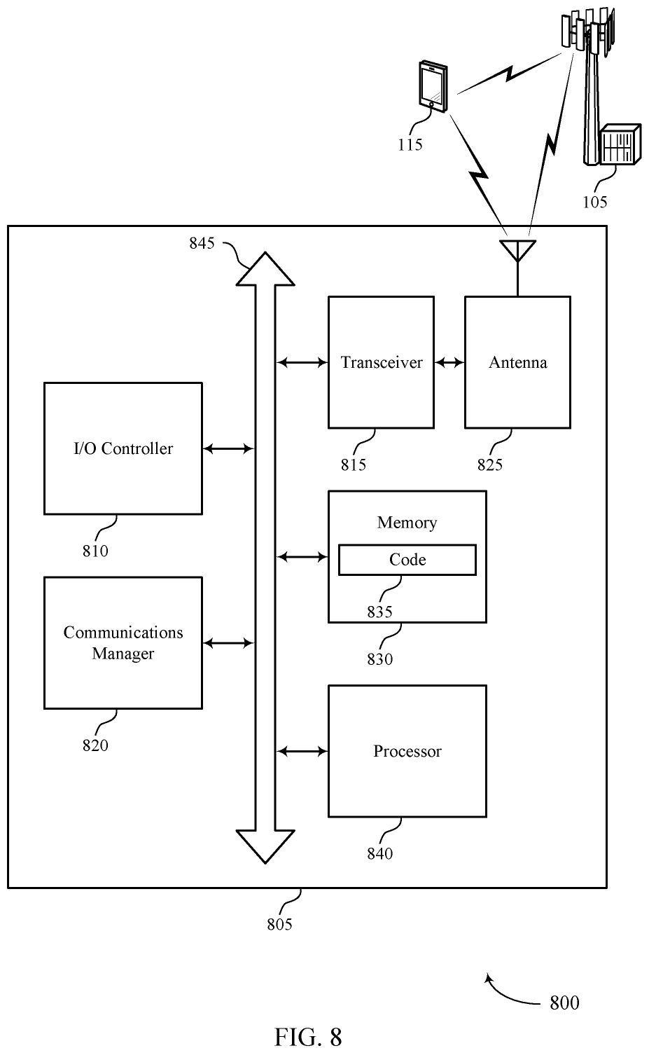

FIG. 8 shows a diagram of a system 800 including a device 805 that supports performing a channel access procedure on multiple component carriers in a shared radio frequency spectrum band in accordance with one or more aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting performing a channel access procedure on multiple component carriers in a shared radio frequency spectrum band). For example, the device 805 or a component of the device 805 may include a processor 840 and memory 830 coupled to the processor 840, the processor 840 and memory 830 configured to perform various functions described herein.

The communications manager 820 may support multicarrier wireless communication at a first UE in a wireless communications system in accordance with examples as disclosed herein. For example, the communications manager 820 may be configured as or otherwise support a means for determining a transmit diversity configuration indicating a transmit diversity criterion for declaring a result of a channel access procedure for a set of multiple component carriers in a shared radio frequency spectrum band. The communications manager 820 may be configured as or otherwise support a means for performing the channel access procedure for the set of multiple component carriers in the shared radio frequency spectrum band to determine the result of the channel access procedure based on the transmit diversity criterion. The communications manager 820 may be configured as or otherwise support a means for transmitting or refraining from transmitting a message over at least one component carrier of the set of multiple component carriers based on the result of the channel access procedure.

Additionally or alternatively, the communications manager 820 may support wireless communication at a first UE in accordance with examples as disclosed herein. For example, the communications manager 820 may be configured as or otherwise support a means for measuring one or more sidelink reference signals to determine an observed interference level at the first UE. The communications manager 820 may be configured as or otherwise support a means for communicating, to a second UE, a message including an indication of a transmit diversity criterion for declaring a result of a channel access procedure for a set of multiple component carriers in a shared radio frequency spectrum band based on the observed interference level satisfying a threshold.

By including or configuring the communications manager 820 in accordance with examples as described herein, the device 805 may support techniques for improved communication reliability, reduced latency, reduced power consumption, more efficient utilization of communication resources. For example, the device 805 may support efficient channel access procedures (e.g., LBT procedures), which may increase its battery life. Additionally, the device 805 may experience improved communication reliability by supporting efficient channel access procedures for multiple component carrier transmissions in a shared radio frequency spectrum band.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of performing a channel access procedure on multiple component carriers in a shared radio frequency spectrum band as described herein, or the processor 840 and the memory 830 may be otherwise configured to perform or support such operations.

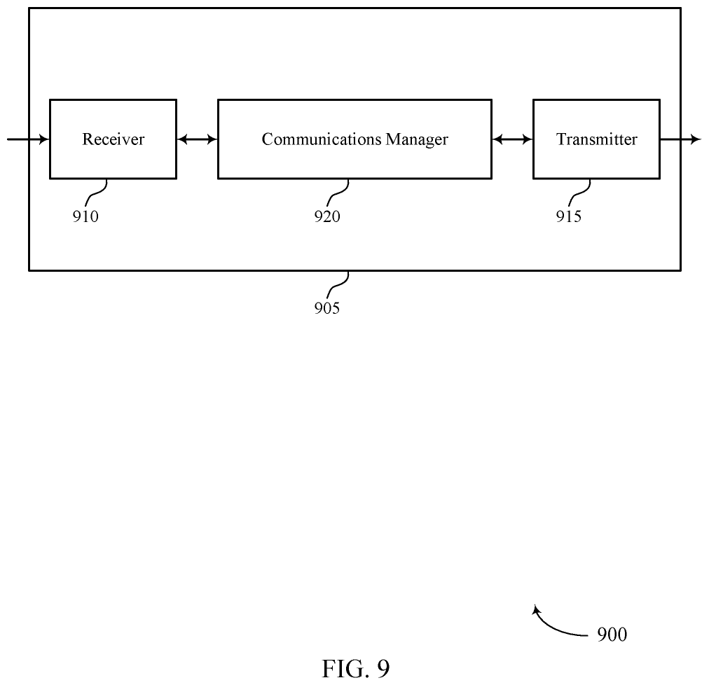

FIG. 9 shows a block diagram 900 of a device 905 that supports performing a channel access procedure on multiple component carriers in a shared radio frequency spectrum band in accordance with one or more aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to performing a channel access procedure on multiple component carriers in a shared radio frequency spectrum band). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to performing a channel access procedure on multiple component carriers in a shared radio frequency spectrum band). In some examples, the transmitter 915 may be co-located with a receiver 910 in a transceiver component. The transmitter 915 may utilize a single antenna or a set of multiple antennas.

The communications manager 920, the receiver 910, the transmitter 915, or various combinations thereof or various components thereof may be examples of means for performing various aspects of performing a channel access procedure on multiple component carriers in a shared radio frequency spectrum band as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a node in accordance with examples as disclosed herein. For example, the communications manager 920 may be configured as or otherwise support a means for transmitting a transmit diversity configuration indicating a transmit diversity criterion for declaring a result of a channel access procedure for a set of multiple component carriers in a shared radio frequency spectrum band. The communications manager 920 may be configured as or otherwise support a means for measuring one or more reference signals to determine an observed interference level at the node. The communications manager 920 may be configured as or otherwise support a means for communicating, to a UE, a message including an indication of an updated transmit diversity criterion for declaring the result of the channel access procedure for the set of multiple component carriers in the shared radio frequency spectrum band based on the observed interference level satisfying a threshold.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced power consumption, more efficient utilization of communication resources for channel access procedures (e.g., LBT procedures) on multiple component carriers in a shared radio frequency spectrum band.

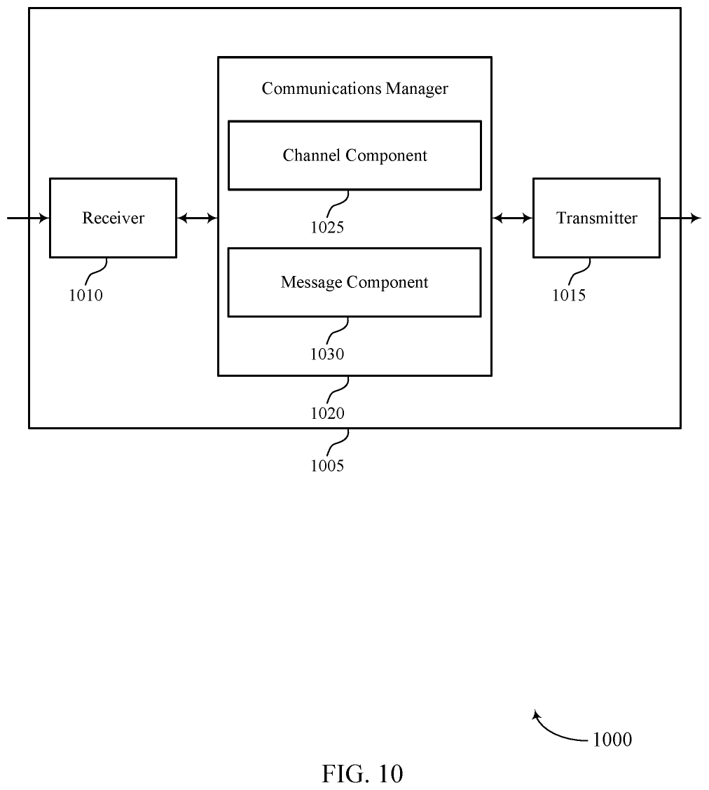

FIG. 10 shows a block diagram 1000 of a device 1005 that supports performing a channel access procedure on multiple component carriers in a shared radio frequency spectrum band in accordance with one or more aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to performing a channel access procedure on multiple component carriers in a shared radio frequency spectrum band). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to performing a channel access procedure on multiple component carriers in a shared radio frequency spectrum band). In some examples, the transmitter 1015 may be co-located with a receiver 1010 in a transceiver component. The transmitter 1015 may utilize a single antenna or a set of multiple antennas.

The device 1005, or various components thereof, may be an example of means for performing various aspects of performing a channel access procedure on multiple component carriers in a shared radio frequency spectrum band as described herein. For example, the communications manager 1020 may include a channel component 1025 and a message component 1030, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a node in accordance with examples as disclosed herein. The message component 1030 may be configured as or otherwise support a means for transmitting a transmit diversity configuration indicating a transmit diversity criterion for declaring a result of a channel access procedure for a set of multiple component carriers in a shared radio frequency spectrum band. The channel component 1025 may be configured as or otherwise support a means for measuring one or more reference signals to determine an observed interference level at the node. The message component 1030 may be configured as or otherwise support a means for communicating, to a UE, a message including an indication of an updated transmit diversity criterion for declaring the result of the channel access procedure for the set of multiple component carriers in the shared radio frequency spectrum band based on the observed interference level satisfying a threshold.

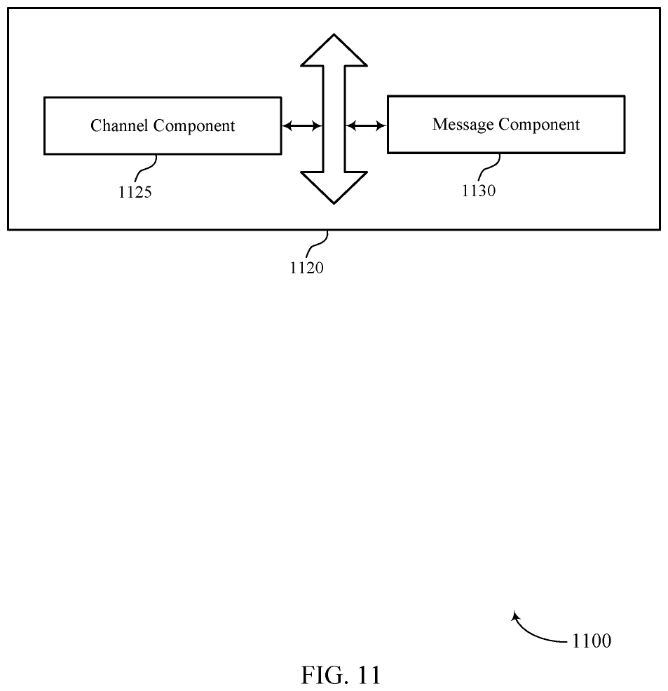

FIG. 11 shows a block diagram 1100 of a communications manager 1120 that supports performing a channel access procedure on multiple component carriers in a shared radio frequency spectrum band in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of performing a channel access procedure on multiple component carriers in a shared radio frequency spectrum band as described herein. For example, the communications manager 1120 may include a channel component 1125 and a message component 1130, or any combination thereof. Each of these components may communicate, directly or indirectly, with one another (e.g., via one or more buses).

The communications manager 1120 may support wireless communication at a node in accordance with examples as disclosed herein. The message component 1130 may be configured as or otherwise support a means for transmitting a transmit diversity configuration indicating a transmit diversity criterion for declaring a result of a channel access procedure for a set of multiple component carriers in a shared radio frequency spectrum band. In some examples, the channel component 1125 may be configured as or otherwise support a means for measuring one or more reference signals to determine an observed interference level at the node. In some examples, the message component 1130 may be configured as or otherwise support a means for communicating, to a UE, a message including an indication of an updated transmit diversity criterion for declaring the result of the channel access procedure for the set of multiple component carriers in the shared radio frequency spectrum band based on the observed interference level satisfying a threshold.

The message component 1130 may be configured as or otherwise support a means for transmitting a control message indicating the transmit diversity configuration. The control message may include an RRC message, a MAC-CE message, or a DCI message, or a combination thereof. The message component 1130 may be configured as or otherwise support a means for transmitting an indication of the transmit diversity criterion for declaring the result of the channel access procedure for the plurality of component carriers in the shared radio frequency spectrum band based at least in part on an observed interference level satisfying a threshold. The message component 1130 may be configured as or otherwise support a means for transmitting the transmit diversity configuration indicating a redundancy number. In some examples, the redundancy number is greater than or equal to one. In some examples, a product of the redundancy number and a target transmit diversity number is less than or equal to a total number of the plurality of component carriers. In some examples, the transmit diversity threshold number is a multiple of the target transmit diversity number. In some examples, the redundancy number is preconfigured.

In some examples, the redundancy number is based at least in part on a type of application. In some examples, the redundancy number is based at least in part on a total number of component carriers in the wireless communications system. In some examples, the redundancy number is based at least in part on a PDB associated with the channel access procedure. In some examples, the redundancy number is based at least in part on a period when the channel access procedure is performed and a PDB associated with the channel access procedure. In some examples, the redundancy number is based at least in part on a defined number of component carriers. The message component 1130 may be configured as or otherwise support a means for transmitting interference information. The channel component 1125 may be configured as or otherwise support a means for determining a CBR based at least in part on measuring one or more reference signals, the interference information including the CBR.

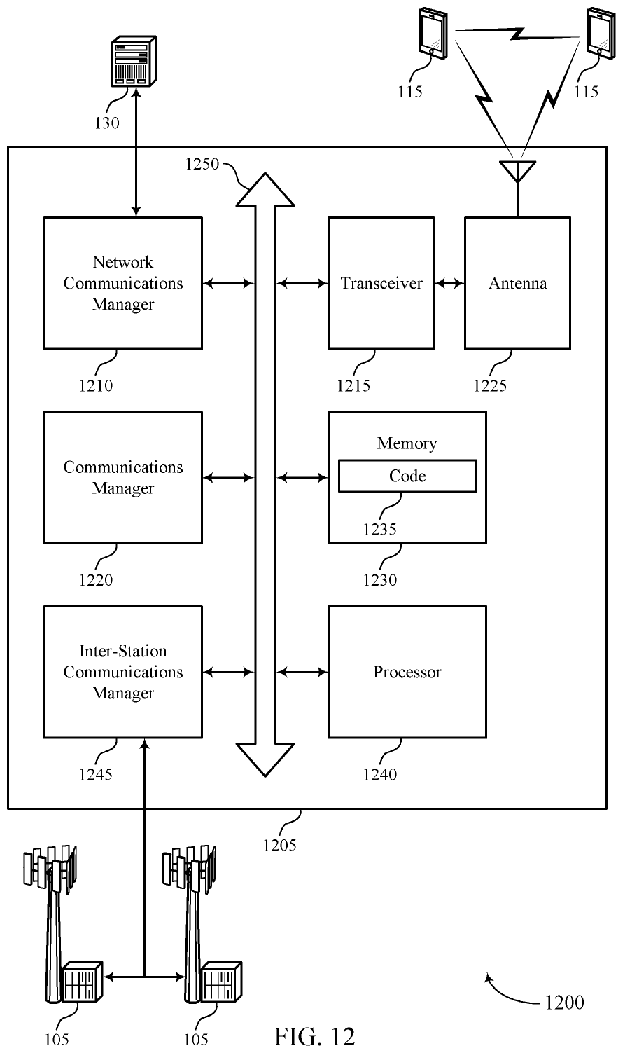

FIG. 12 shows a diagram of a system 1200 including a device 1205 that supports performing a channel access procedure on multiple component carriers in a shared radio frequency spectrum band in accordance with one or more aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting performing a channel access procedure on multiple component carriers in a shared radio frequency spectrum band). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a node in accordance with examples as disclosed herein. For example, the communications manager 1220 may be configured as or otherwise support a means for transmitting a transmit diversity configuration indicating a transmit diversity criterion for declaring a result of a channel access procedure for a set of multiple component carriers in a shared radio frequency spectrum band. The communications manager 1220 may be configured as or otherwise support a means for measuring one or more reference signals to determine an observed interference level at the node. The communications manager 1220 may be configured as or otherwise support a means for communicating, to a UE, a message including an indication of an updated transmit diversity criterion for declaring the result of the channel access procedure for the set of multiple component carriers in the shared radio frequency spectrum band based on the observed interference level satisfying a threshold. By including or configuring the communications manager 1220 in accordance with examples as described herein, the device 1205 may support techniques for improved communication reliability, reduced latency, and more efficient utilization of communication resources.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of performing a channel access procedure on multiple component carriers in a shared radio frequency spectrum band as described herein, or the processor 1240 and the memory 1230 may be otherwise configured to perform or support such operations.

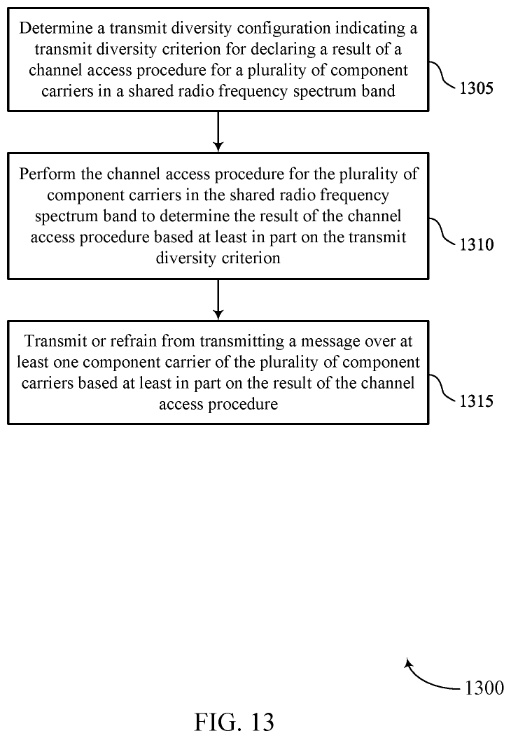

FIG. 13 shows a flowchart illustrating a method 1300 that supports performing a channel access procedure on multiple component carriers in a shared radio frequency spectrum band in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include determining a transmit diversity configuration indicating a transmit diversity criterion for declaring a result of a channel access procedure for a set of multiple component carriers in a shared radio frequency spectrum band. The operations of 1305 may be performed in accordance with examples as disclosed herein. In some examples, aspects of the operations of 1305 may be performed by a configuration component 725 as described with reference to FIG. 7.

At 1310, the method may include performing the channel access procedure for the set of multiple component carriers in the shared radio frequency spectrum band to determine the result of the channel access procedure based on the transmit diversity criterion. The operations of 1310 may be performed in accordance with examples as disclosed herein. In some examples, aspects of the operations of 1310 may be performed by an access component 730 as described with reference to FIG. 7.

At 1315, the method may include transmitting or refraining from transmitting a message over at least one component carrier of the set of multiple component carriers based on the result of the channel access procedure. The operations of 1315 may be performed in accordance with examples as disclosed herein. In some examples, aspects of the operations of 1315 may be performed by a message component 735 as described with reference to FIG. 7.

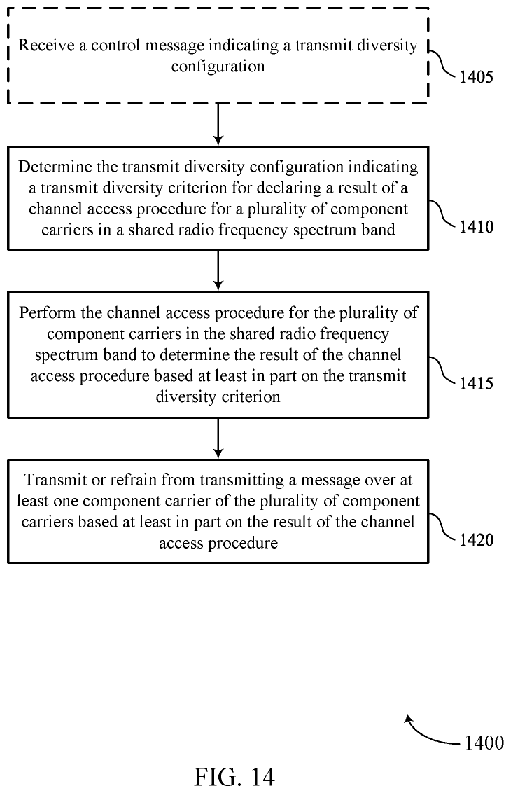

FIG. 14 shows a flowchart illustrating a method 1400 that supports performing a channel access procedure on multiple component carriers in a shared radio frequency spectrum band in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving a control message indicating a transmit diversity configuration. The control message may include an RRC message, a MAC-CE message, or a DCI message, or a combination thereof. The operations of 1405 may be performed in accordance with examples as disclosed herein. In some examples, aspects of the operations of 1405 may be performed by a message component 735 as described with reference to FIG. 7.

At 1410, the method may include determining the transmit diversity configuration indicating a transmit diversity criterion for declaring a result of a channel access procedure for a set of multiple component carriers in a shared radio frequency spectrum band. The operations of 1410 may be performed in accordance with examples as disclosed herein. In some examples, aspects of the operations of 1410 may be performed by a configuration component 725 as described with reference to FIG. 7.

At 1415, the method may include performing the channel access procedure for the set of multiple component carriers in the shared radio frequency spectrum band to determine the result of the channel access procedure based on the transmit diversity criterion. The operations of 1415 may be performed in accordance with examples as disclosed herein. In some examples, aspects of the operations of 1415 may be performed by an access component 730 as described with reference to FIG. 7.

At 1420, the method may include transmitting or refraining from transmitting a message over at least one component carrier of the set of multiple component carriers based on the result of the channel access procedure. The operations of 1420 may be performed in accordance with examples as disclosed herein. In some examples, aspects of the operations of 1420 may be performed by a message component 735 as described with reference to FIG. 7.

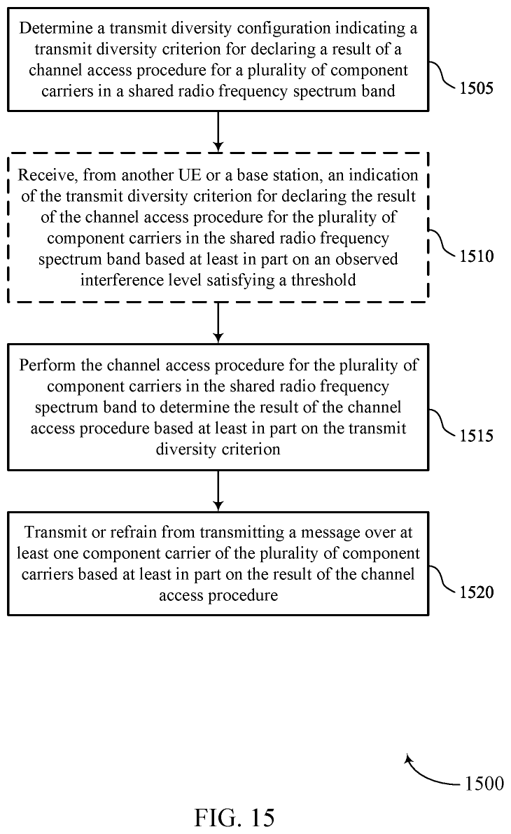

FIG. 15 shows a flowchart illustrating a method 1500 that supports performing a channel access procedure on multiple component carriers in a shared radio frequency spectrum band in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include determining a transmit diversity configuration indicating a transmit diversity criterion for declaring a result of a channel access procedure for a set of multiple component carriers in a shared radio frequency spectrum band. The operations of 1505 may be performed in accordance with examples as disclosed herein. In some examples, aspects of the operations of 1505 may be performed by a configuration component 725 as described with reference to FIG. 7.

At 1510, the method may include receiving, from a second UE or a node, an indication of the transmit diversity criterion for declaring the result of the channel access procedure for the set of multiple component carriers in the shared radio frequency spectrum band based on an observed interference level satisfying a threshold. The operations of 1510 may be performed in accordance with examples as disclosed herein. In some examples, aspects of the operations of 1510 may be performed by a configuration component 725 as described with reference to FIG. 7.

At 1515, the method may include performing the channel access procedure for the set of multiple component carriers in the shared radio frequency spectrum band to determine the result of the channel access procedure based on the transmit diversity criterion. The operations of 1515 may be performed in accordance with examples as disclosed herein. In some examples, aspects of the operations of 1515 may be performed by an access component 730 as described with reference to FIG. 7.

At 1520, the method may include transmitting or refraining from transmitting a message over at least one component carrier of the set of multiple component carriers based on the result of the channel access procedure. The operations of 1520 may be performed in accordance with examples as disclosed herein. In some examples, aspects of the operations of 1520 may be performed by a message component 735 as described with reference to FIG. 7.

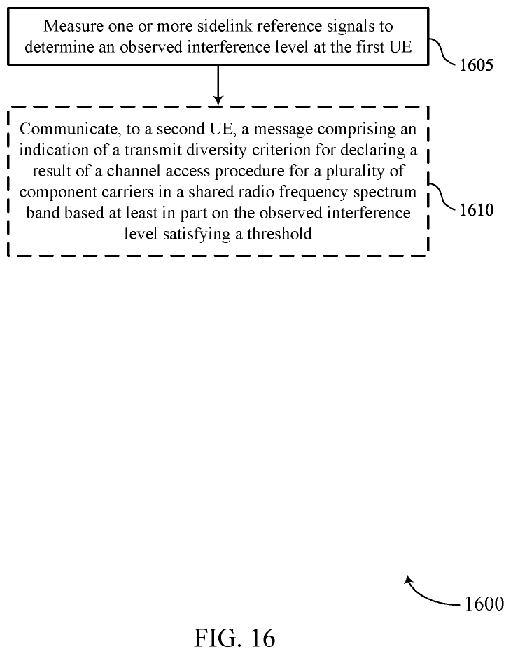

FIG. 16 shows a flowchart illustrating a method 1600 that supports performing a channel access procedure on multiple component carriers in a shared radio frequency spectrum band in accordance with one or more aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1605, the method may include measuring one or more sidelink reference signals to determine an observed interference level at the first UE. The operations of 1605 may be performed in accordance with examples as disclosed herein. In some examples, aspects of the operations of 1605 may be performed by a reference signal component 740 as described with reference to FIG. 7.

At 1610, the method may include communicating, to a second UE, a message including an indication of a transmit diversity criterion for declaring a result of a channel access procedure for a set of multiple component carriers in a shared radio frequency spectrum band based on the observed interference level satisfying a threshold. The operations of 1610 may be performed in accordance with examples as disclosed herein. In some examples, aspects of the operations of 1610 may be performed by a message component 735 as described with reference to FIG. 7.

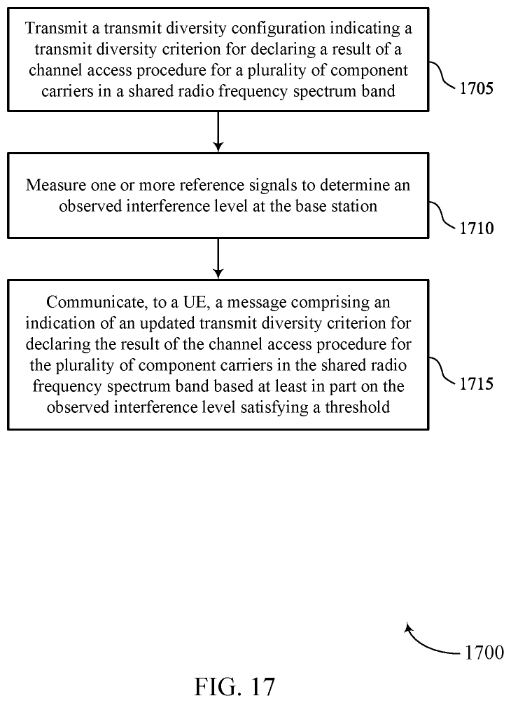

FIG. 17 shows a flowchart illustrating a method 1700 that supports performing a channel access procedure on multiple component carriers in a shared radio frequency spectrum band in accordance with one or more aspects of the present disclosure. The operations of the method 1700 may be implemented by a base station or its components as described herein. For example, the operations of the method 1700 may be performed by a base station as described with reference to FIGS. 9 through 12. In some examples, a base station may execute a set of instructions to control the functional elements of the base station to perform the described functions. Additionally or alternatively, the base station may perform aspects of the described functions using special-purpose hardware.

At 1705, the method may include transmitting a transmit diversity configuration indicating a transmit diversity criterion for declaring a result of a channel access procedure for a plurality of component carriers in a shared radio frequency spectrum band. The operations of 1705 may be performed in accordance with examples as disclosed herein. In some examples, aspects of the operations of 1705 may be performed by a message component 1130 as described with reference to FIG. 11.

At 1710, the method may include measuring one or more reference signals to determine an observed interference level at the node. The operations of 1710 may be performed in accordance with examples as disclosed herein. In some examples, aspects of the operations of 1710 may be performed by a channel component 1125 as described with reference to FIG. 11.

At 1715, the method may include communicating, to a UE, a message including an indication of an updated transmit diversity criterion for declaring the result of the channel access procedure for the plurality of component carriers in the shared radio frequency spectrum band based at least in part on the observed interference level satisfying a threshold. The operations of 1715 may be performed in accordance with examples as disclosed herein. In some examples, aspects of the operations of 1715 may be performed by a message component 1130 as described with reference to FIG. 11.

The following provides an overview of aspects of the present disclosure:

Aspect 1: A method for multicarrier wireless communication at a first UE in a wireless communications system, comprising: determining a transmit diversity configuration indicating a transmit diversity criterion for declaring a result of a channel access procedure for a plurality of CCs in a shared radio frequency spectrum band; performing the channel access procedure for the plurality of CCs in the shared radio frequency spectrum band to determine the result of the channel access procedure based at least in part on the transmit diversity criterion; and transmitting or refraining from transmitting a message over at least one CC of the plurality of CCs based at least in part on the result of the channel access procedure.

Aspect 2: The method of aspect 1, further comprising: receiving a control message indicating the transmit diversity configuration, wherein the control message comprises an RRC message, a MAC-CE message, or a DCI message, or a combination thereof.

Aspect 3: The method of any of aspects 1 through 2, further comprising: receiving, from a second UE or a node, an indication of the transmit diversity criterion for declaring the result of the channel access procedure for the plurality of CCs in the shared radio frequency spectrum band based at least in part on an observed interference level satisfying a threshold.

Aspect 4: The method of any of aspects 1 through 3, further comprising: receiving the transmit diversity configuration indicating a redundancy number; and transmitting or refraining from transmitting the message over the at least one CC of the plurality of CCs based at least in part on the redundancy number.

Aspect 5: The method of any of aspects 1 through 4, further comprising: transmitting or refraining from transmitting the message over the at least one CC of the plurality of CCs based at least in part on a transmit diversity threshold number, wherein the transmit diversity threshold number is a product of a redundancy number and a target transmit diversity number of CCs specified for transmission of the message.

Aspect 6: The method of aspect 5, wherein the redundancy number is greater than or equal to one.

Aspect 7: The method of any of aspects 5 through 6, wherein the product of the redundancy number and the target transmit diversity number is less than or equal to a total number of the plurality of CCs.

Aspect 8: The method of any of aspects 5 through 7, wherein the transmit diversity threshold number is a multiple of the target transmit diversity number.

Aspect 9: The method of any of aspects 5 through 8, wherein the redundancy number is preconfigured.

Aspect 10: The method of any of aspects 5 through 9, wherein the redundancy number is based at least in part on a type of application of the message.

Aspect 11: The method of any of aspects 5 through 10, wherein the redundancy number is based at least in part on the total number of CCs in the wireless communications system.

Aspect 12: The method of any of aspects 5 through 11, wherein the redundancy number is based at least in part on a PDB associated with the channel access procedure.

Aspect 13: The method of any of aspects 5 through 12, wherein the redundancy number is based at least in part on a period when the channel access procedure is performed and a PDB associated with the channel access procedure.

Aspect 14: The method of any of aspects 5 through 13, wherein the redundancy number is based at least in part on a defined number of CCs specified for the message.

Aspect 15: The method of any of aspects 5 through 14, wherein the redundancy number is determined based at least in part on interference information for one or more CCs of the plurality of CCs.

Aspect 16: The method of aspect 15, further comprising: receiving the interference information from a node in wireless communication with the first UE, or a second UE in sidelink communication with the first UE, or both; and transmitting or refraining from transmitting the message over the at least one CC of the plurality of CCs based at least in part on the interference information.

Aspect 17: The method of any of aspects 15 through 16, further comprising: determining a CBR based at least in part on measuring one or more reference signals communicated via the one or more CCs of the plurality of CCs, the interference information comprising the CBR.

Aspect 18: The method of any of aspects 15 through 17, further comprising: determining a plurality of previous results of a plurality of previous channel access procedures performed by the first UE; and estimating that the one or more CCs of the plurality of CCs are available for transmission of the message based at least in part on the plurality of previous results of the plurality of previous channel access procedures performed by the first UE, wherein the redundancy number is determined based at least in part on the estimated one or more CCs of the plurality of CCs that are available for transmission of the message.

Aspect 19: The method of any of aspects 1 through 18, further comprising: determining one or more CCs of the plurality of CCs are available for transmission of the message based at least in part on the channel access procedure; declaring the result as a channel access failure based at least in part on a number of the one or more CCs satisfying a transmit diversity threshold number specified in the transmit diversity criterion, wherein the number of one or more CCs are available for transmission of the message; and refraining from transmitting the message based at least in part on the channel access failure.

Aspect 20: The method of any of aspects 1 through 19, further comprising: determining one or more CCs of the plurality of CCs are available for transmission of the message based at least in part on the channel access procedure; and declaring the result as a channel access success based at least in part on a number of the one or more CCs satisfying a transmit diversity threshold number specified in the transmit diversity criterion, wherein the number of one or more CCs are available for transmission of the message.

Aspect 21: The method of aspect 20, further comprising: transmitting the message on the one or more CCs based at least in part on declaring the result the channel access success.

Aspect 22: The method of any of aspects 1 through 21, further comprising: determining a probability of the result of the channel access procedure using a probability model; and declaring the result of the channel access procedure for based at least in part on the probability.

Aspect 23: A method for wireless communication at a first UE, comprising: measuring one or more sidelink reference signals to determine an observed interference level at the first UE; and communicating, to a second UE, a message comprising an indication of a transmit diversity criterion for declaring a result of a channel access procedure for a plurality of CCs in a shared radio frequency spectrum band based at least in part on the observed interference level satisfying a threshold.

Aspect 24: The method of aspect 23, wherein communicating the message comprises: communicating the message comprising the indication of the transmit diversity criterion that specifies a transmit diversity threshold number for declaring the result as a channel access failure based at least in part on a number of one or more CCs satisfying the transmit diversity threshold number specified in the transmit diversity criterion, wherein the number of one or more CCs are available for transmission.

Aspect 25: The method of any of aspects 23 through 24, wherein communicating the message comprises: communicating the message comprising the indication of the transmit diversity criterion that specifies a transmit diversity threshold number for declaring the result as a channel access success based at least in part on a number of one or more CCs satisfying the transmit diversity threshold number specified in the transmit diversity criterion, wherein the number of one or more CCs are available for transmission.

Aspect 26: The method of any of aspects 23 through 25, wherein communicating the message comprises: communicating the message comprising the indication of the transmit diversity criterion that specifies a transmit diversity threshold number that is a product of a redundancy number and a target transmit diversity number of CCs.

Aspect 27: The method of aspect 26, wherein the redundancy number is greater than one.

Aspect 28: The method of any of aspects 26 through 27, wherein the transmit diversity threshold number is a multiple of the target transmit diversity number.

Aspect 29: A method for wireless communication at a node, comprising: transmitting a transmit diversity configuration indicating a transmit diversity criterion for declaring a result of a channel access procedure for a plurality of CCs in a shared radio frequency spectrum band; measuring one or more reference signals to determine an observed interference level at the node; and communicating, to a UE, a message comprising an indication of an updated transmit diversity criterion for declaring the result of the channel access procedure for the plurality of CCs in the shared radio frequency spectrum band based at least in part on the observed interference level satisfying a threshold.

Aspect 30: An apparatus for multicarrier wireless communication at a first UE in a wireless communications system, comprising a processor; and memory coupled to the processor, the processor configured to perform a method of any of aspects 1 through 22.

Aspect 31: An apparatus for multicarrier wireless communication at a first UE in a wireless communications system, comprising at least one means for performing a method of any of aspects 1 through 22.

Aspect 32: A non-transitory computer-readable medium storing code for multicarrier wireless communication at a first UE in a wireless communications system, the code comprising instructions executable by a processor to perform a method of any of aspects 1 through 22.

Aspect 33: An apparatus for wireless communication at a first UE, comprising a processor; and memory coupled to the processor, the processor configured to perform a method of any of aspects 23 through 28.

Aspect 34: An apparatus for wireless communication at a first UE, comprising at least one means for performing a method of any of aspects 23 through 28.

Aspect 35: A non-transitory computer-readable medium storing code for wireless communication at a first UE, the code comprising instructions executable by a processor to perform a method of any of aspects 23 through 28.

Aspect 36: An apparatus for wireless communication at a node, comprising a processor; and memory coupled to the processor, the processor configured to cause the apparatus to perform a method of aspect 29.

Aspect 37: An apparatus for wireless communication at a node, comprising at least one means for performing a method of aspect 29.

Aspect 38: A non-transitory computer-readable medium storing code for wireless communication at a node, the code comprising instructions executable by a processor to perform a method of aspect 29.

It should be noted that the methods described herein describe possible implementations, and that the operations and the features may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example feature that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for multicarrier wireless communication at a first user equipment (UE) in a wireless communications system, comprising:
a processor; and
memory coupled to the processor; the processor configured to:
determine a transmit diversity configuration indicating a transmit diversity criterion to declare a result of a channel access procedure for a plurality of component carriers in a shared radio frequency spectrum band;
perform the channel access procedure for the plurality of component carriers in the shared radio frequency spectrum band to determine the result of the channel access procedure based at least in part on the transmit diversity criterion; and
transmit or refrain from transmitting a message over at least one component carrier of the plurality of component carriers based at least in part on the result of the channel access procedure.

2. The apparatus of claim 1, wherein the processor is further configured to:
receive a control message indicating the transmit diversity configuration,
wherein the control message comprises a radio resource control message, a medium access control-control element (MAC-CE) message, or a downlink control information message, or a combination thereof.

3. The apparatus of claim 1, wherein the processor is further configured to:
receive, from a second UE or a node, an indication of the transmit diversity criterion to declare the result of the channel access procedure for the plurality of component carriers in the shared radio frequency spectrum band based at least in part on an observed interference level satisfying a threshold.

4. The apparatus of claim 1, wherein the processor is further configured to:
receive the transmit diversity configuration indicating a redundancy number; and
transmit or refrain from transmitting the message over the at least one component carrier of the plurality of component carriers based at least in part on the redundancy number.

5. The apparatus of claim 1, wherein the processor is further configured to:
transmit or refrain from transmitting the message over the at least one component carrier of the plurality of component carriers based at least in part on a transmit diversity threshold number, wherein the transmit diversity threshold number is a product of a redundancy number and a target transmit diversity number of component carriers specified for transmission of the message.

6. The apparatus of claim 5, wherein the redundancy number is greater than or equal to one.

7. The apparatus of claim 5, wherein the product of the redundancy number and the target transmit diversity number is less than or equal to a total number of the plurality of component carriers.

8. The apparatus of claim 5, wherein the transmit diversity threshold number is a multiple of the target transmit diversity number.

9. The apparatus of claim 5, wherein the redundancy number is preconfigured.

10. The apparatus of claim 5, wherein the redundancy number is based at least in part on a type of application of the message.

11. The apparatus of claim 5, wherein the redundancy number is based at least in part on a total number of component carriers in the wireless communications system.

12. The apparatus of claim 5, wherein the redundancy number is based at least in part on a packet delay budget associated with the channel access procedure.

13. The apparatus of claim 5, wherein the redundancy number is based at least in part on a period when the channel access procedure is performed and a packet delay budget associated with the channel access procedure.

14. The apparatus of claim 5, wherein the redundancy number is based at least in part on a defined number of component carriers specified for the message.

15. The apparatus of claim 5, wherein the redundancy number is determined based at least in part on interference information for one or more component carriers of the plurality of component carriers.

16. The apparatus of claim 15, wherein the processor is further configured to:
receive the interference information from a node in wireless communication with the first UE, or a second UE in sidelink communication with the first UE, or both; and
transmit or refrain from transmitting the message over the at least one component carrier of the plurality of component carriers based at least in part on the interference information.

17. The apparatus of claim 15, wherein the processor is further configured to:
determine a channel busy ratio based at least in part on measurement of one or more reference signals communicated via the one or more component carriers of the plurality of component carriers, the interference information comprising the channel busy ratio.

18. The apparatus of claim 15, wherein the processor is further configured to:
determine a plurality of previous results of a plurality of previous channel access procedures performed by the first UE; and
estimate that the one or more component carriers of the plurality of component carriers are available for transmission of the message based at least in part on the plurality of previous results of the plurality of previous channel access procedures performed by the first UE,
wherein the redundancy number is determined based at least in part on the one or more component carriers of the plurality of component carriers that are available for transmission of the message.

19. The apparatus of claim 1, wherein the processor is further configured to:
determine one or more component carriers of the plurality of component carriers are available for transmission of the message based at least in part on the channel access procedure;
declare the result as a channel access failure based at least in part on a number of the one or more component carriers satisfying a transmit diversity threshold number specified in the transmit diversity criterion, wherein the number of the one or more component carriers are available for transmission of the message; and
refrain from transmitting the message based at least in part on the channel access failure.

20. The apparatus of claim 1, wherein the processor is further configured to:
determine one or more component carriers of the plurality of component carriers are available for transmission of the message based at least in part on the channel access procedure; and
declare the result as a channel access success based at least in part on a number of the one or more component carriers satisfying a transmit diversity threshold number specified in the transmit diversity criterion, wherein the number of the one or more component carriers are available for transmission of the message.

21. The apparatus of claim 20, further comprising:
an antenna array configured to transmit the message on the one or more component carriers based at least in part on declaring the result the channel access success.

22. The apparatus of claim 1, wherein the processor is further configured to:
determine a probability of the result of the channel access procedure using a probability model; and
declare the result of the channel access procedure for based at least in part on the probability.

23. An apparatus for wireless communication at a first user equipment (UE), comprising:
a processor; and
memory coupled to the processor, the processor configured to:
measure one or more sidelink reference signals to determine an observed interference level at the first UE; and
communicate, to a second UE, a message comprising an indication of a transmit diversity criterion to declare a result of a channel access procedure for a plurality of component carriers in a shared radio frequency spectrum band based at least in part on the observed interference level satisfying a threshold.

24. The apparatus of claim 23, wherein the processor is further configured to:
communicate the message comprising the indication of the transmit diversity criterion that specifies a transmit diversity threshold number to declare the result as a channel access failure based at least in part on a number of one or more component carriers satisfying the transmit diversity threshold number specified in the transmit diversity criterion, wherein the number of one or more component carriers are available for transmission.

25. The apparatus of claim 23, wherein the processor is further configured to:
communicate the message comprising the indication of the transmit diversity criterion that specifies a transmit diversity threshold number to declare the result as a channel access success based at least in part on a number of one or more component carriers satisfying the transmit diversity threshold number specified in the transmit diversity criterion, wherein the number of one or more component carriers are available for transmission.

26. The apparatus of claim 23, wherein the processor is further configured to:
communicate the message comprising the indication of the transmit diversity criterion that specifies a transmit diversity threshold number that is a product of a redundancy number and a target transmit diversity number of component carriers.

27. The apparatus of claim 26, wherein the redundancy number is greater than one.

28. The apparatus of claim 26, wherein the transmit diversity threshold number is a multiple of the target transmit diversity number.

29. An apparatus for wireless communication at a node, comprising:
a processor; and
memory coupled to the processor, the processor configured to:
transmit a transmit diversity configuration indicating a transmit diversity criterion to declare a result of a channel access procedure for a plurality of component carriers in a shared radio frequency spectrum band;
measure one or more reference signals to determine an observed interference level at the node; and
communicate, to a user equipment (UE), a message comprising an indication of an updated transmit diversity criterion to declare the result of the channel access procedure for the plurality of component carriers in the shared radio frequency spectrum band based at least in part on the observed interference level satisfying a threshold.

30. A method for multicarrier wireless communication at a first user equipment (UE) in a wireless communications system, comprising:
determining a transmit diversity configuration indicating a transmit diversity criterion to declare a result of a channel access procedure for a plurality of component carriers in a shared radio frequency spectrum band;
performing the channel access procedure for the plurality of component carriers in the shared radio frequency spectrum band to determine the result of the channel access procedure based at least in part on the transmit diversity criterion; and
transmitting or refraining from transmitting a message over at least one component carrier of the plurality of component carriers based at least in part on the result of the channel access procedure.
